(19) United States
(12) Patent Application Publication
(10) Pub. No.: US 2009/0070426 A1
(43) Pub. Date: Mar. 12, 2009

(54) CONTENT CONTRIBUTION AND PLACEMENT THROUGH EXTERNAL SOCIAL COMMUNITIES

(76) Inventors: David Bruce McCauley, Geenwood, CA (US); Kenneth J. Kratz, Yorktown, IN (US); James Thomas Stanley, Fishers, IN (US); Chris Huffman, Indianapolis, IN (US); Christopher Kemper, Indianapolis, IN (US); Jim Daugherty, Noblesville, IN (US); Christopher Lawrence Yates, Indianapolis, IN (US)

Correspondence Address: Raj Abhyanker LLP;c/o Intellevate, P.O. Box 52050, Minneapolis, MN, 55402, US

(21) Appl. No.: 12/043,971

(22) Filed: Mar. 7, 2008

Related U.S. Application Data
(63) Continuation-in-part of application No. 11/900,481, filed on Sep. 11, 2007.

(51) Int. Cl. G06F 15/16

(52) U.S. Cl. 709/205

(57) ABSTRACT

A method and system for content distribution and placement through external social communities is disclosed. In one embodiment, a method includes building a work of authorship through a collective coordination of authors of the work of authorship in a community environment, providing a portion of content of the work of authorship on an external social community through a feed from the community environment to the external social community, processing a response of a user of the external social community in contributing to the work of authorship, and integrating the response of the user of the external social community in the work of authorship. The method may include providing the feed as of a Real Simple Syndication feed, as an embeddable widget, and/or an activity announcement based on an update of the work of authorship in the community environment.

### CLAIM OF PRIORITY

This patent application is a Continuation-in-Part patent application claiming priority from U.S. patent application Ser. No. 11/900,481 titled COMMUNITY-BASED COMMUNITY PROJECT CONTENT CREATION SYSTEM AND METHOD filed on Sep. 11, 2007.

### FIELD OF TECHNOLOGY

This disclosure relates generally to the technical field of communications and, in one example embodiment, to a method and system of content contribution and placement through external social communities.

### BACKGROUND

The creation of a work of authorship (e.g., a yearbook, a novel, a book, an essay, a movie, etc.) may need input from a variety of contributors (e.g., friends, collaborators, co-authors, editors, etc.). Furthermore, creating the work of authorship may require collecting information (e.g., pictures, quotes, video clips, text clips, etc.) from different sources (e.g., books, private collections, media outlets, etc.).

An author (e.g., writer, contributor, editor, etc.) of the work of authorship may be a member of an external social community (e.g., Facebook®, LinkedIn®, Plaxo®, etc.). The author may not have a way to ask users (e.g., friends, acquaintances, members, etc.) of the external social community to contribute to the work of authorship. Furthermore, it may be difficult for the author to explain a context of where and what portion of the work of authorship the author needs help with (e.g., when the author speaks with the users of the external social community offline). As a result, the work of authorship may not benefit from contributions by users of the external social community.

### SUMMARY

A method and system of community-based project content creation are disclosed. In one aspect, a method includes, building a work of authorship through a collective coordination of authors of the work of authorship in a community environment, providing a portion of content of the work of authorship on an external social community through a feed from the community environment to the external social community, processing a response of a user of the external social community in contributing to the work of authorship, and integrating the response of the user of the external social community in the work of authorship.

The response of the user of the external community may include additional content that is incorporated into the portion of the work of authorship. In addition, the response of the user of the external community may include a discussion commentary to the portion of the content of the work of authorship. The feed from the community environment to the external social community may be displayed on a profile page in the external social community of the authors of the work of authorship collectively coordinating to the building of the work of authorship in the community environment.

The method may include providing the feed as of a Real Simple Syndication (RSS) feed, as an embeddable widget, and/or an activity announcement (e.g., may be presented in the external social community as a question to users of the external social community) based on an update of the work of authorship in the community environment. The method may also include transforming the user of the external social community into the authors of the work of authorship in the community environment when the user of the external social community contributes content to the work of authorship through the response.

In addition, the method may also include customizing a presentation of content of the work of authorship through a template (e.g., may be a poetry book template, a year book template, a novel template, a non-fiction book template, a picture book template, a family book template, and/or a multimedia book template etc.) having a set of guidelines that define a category associated with the work of authorship. The method may include placing content in a region of a page based on the template as directed by a request of the authors.

The method may also include assigning creative control over the placement to an editor author of the authors. The editor author may decide roles of other authors in relation to the work of authorship. The roles may include a section editor role, a writer role, a contributor role, and/or a publisher role. The method may include automatically publishing an update of the portion of the work of authorship embodying the response of the user in other external social community upon integrating the response of the user. The method may also include publishing the work of authorship in a print form and/or an online form. In addition, the method may include distributing the work of authorship through a series of distribution channels including retail distribution partner and/or a wholesale distribution partner.

In another aspect, a method includes creating a work of authorship through a collective contribution of content by members of a community environment and users of an external social community, placing content in predetermined sections of a template embodying a preferred style based on a category of the work of authorship, and printing the work of authorship based on a set of orders received through distribution partner associated with the work of authorship.

The method may include designating the users of the external social community as contributors to the work of authorship in the community environment without designating them as authors of the work of authorship. In addition, the method may include publishing a portion of the work of authorship in the external social community such that users of the external social community can interact with the published content through commentary and/or contribution associated with the published content in the external social community.

In yet another aspect, a system may include a community environment having a suite of services that enable an author to collaborate with other authors in the community environment in writing, producing, formatting, designing and publishing a work of authorship, a network, and a set of external social communities associated with the author that publish a snippet of the authorship in the external social communities such that the snippet enables contribution to the work of authorship by users of the external social community.

The system may also include a content placement module of the community environment to place content and/or the contribution of the work of authorship based on a pre-defined template layout chosen by the author and/or the other authors as a model from which to place the content and/or the contribution associated with the work of authorship. In addition, the system may include the snippet made visible on a profile page of the authors in the external social community.

The methods, system, and apparatuses disclosed herein may be implemented in any means for achieving various aspects, and may be executed in a form of machine-readable medium embodying a set of instruction that, when executed by a machine, causes the machine to perform any of the operation disclosed herein. Other features will be apparent from the accompanying drawing and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of an external collaboration module of a community environment that enables an online project collaboration between user profiles and project profiles communicating with external social communities, according to one embodiment.

FIG. 2 is an exploded view of the community network module of FIG. 1, according to one embodiment.

FIG. 3 is an exploded view of the additional modules of FIG. 1, according to one embodiment.

FIG. 4 is a block diagram illustrating generation of a display view, according to one embodiment.

FIG. 5 is a user interface view displaying a homepage associated with a website, according to one embodiment.

FIG. 6 is a user interface view displaying a login and sign up page associated with the website, according to one embodiment.

FIG. 7 is a user interface view of a webpage associated with a user, according to one embodiment.

FIG. 8 is a user interface view of creating a project profile, according to one embodiment.

FIG. 9 is a user interface view displaying the project profile, according to one embodiment.

FIG. 10A is a user interface view of showing content associated with a first project of the project profile, according to one embodiment.

FIG. 10B is a user interface view of editing the content associated with the first project of the project profile, according to one embodiment.

FIG. 11 is a user interface view displaying comments associated with the first project, according to one embodiment.

FIG. 12 is a user interface view displaying history associated with the first project, according to one embodiment.

FIG. 13 is a user interface view of rating contributors associated with the first project, according to one embodiment.

FIG. 14 is a user interface view of browsing projects, according to one embodiment.

FIG. 15 is a user interface view displaying a discussion associated with the first project, according to one embodiment.

FIG. 16 is a user interface view displaying a user profile, according to one embodiment.

FIG. 17 is a diagrammatic system view of a data processing system in which any of the embodiments disclosed herein may be performed, according to one embodiment.

FIG. 18 is a table view displaying privilege level(s) associated with the user profiles related to a project, according to one embodiment.

FIG. 19A is a process flow of generating an online project collaboration between the project profiles and the user profiles, according to one embodiment.

FIG. 19B is a continuation of the process flow of FIG. 19A illustrating additional processes, according to one embodiment.

FIG. 20 is an exploded view of the external collaboration module of FIG. 1 having a content placement module and other modules, according to one embodiment.

FIG. 21 is an exploded view of the content placement module of FIG. 20, according to one embodiment.

FIG. 22 is a user interface view of applying a theme to a category of works of authorship through the content placement module, according to one embodiment.

FIG. 23 is a user interface view of customizing communication with external social communities, according to one embodiment.

FIG. 24 is a user interface view of content placement by applying the content placement module, according to one embodiment.

FIG. 25 is a contributor invitation view, according to one embodiment.

FIG. 26 is a process flow of building a work of authorship, according to one embodiment.

FIG. 26B is a continuation of the process flow of FIG. 26A illustrating additional processes, according to one embodiment.

FIG. 27 is a process flow of distributing work of authorship through distribution channels, according to one embodiment.

Other features of the present embodiments will be apparent from the accompanying drawings and from the detailed description that follows.

### DETAILED DESCRIPTION

A method and system of community-based project content creation are disclosed. In the following description, for the purposes of explanation, numerous specific details are set forth in order to provide a thorough understanding of the various embodiments. It will be evident, however to one skilled in the art that the various embodiments may be practiced without these specific details.

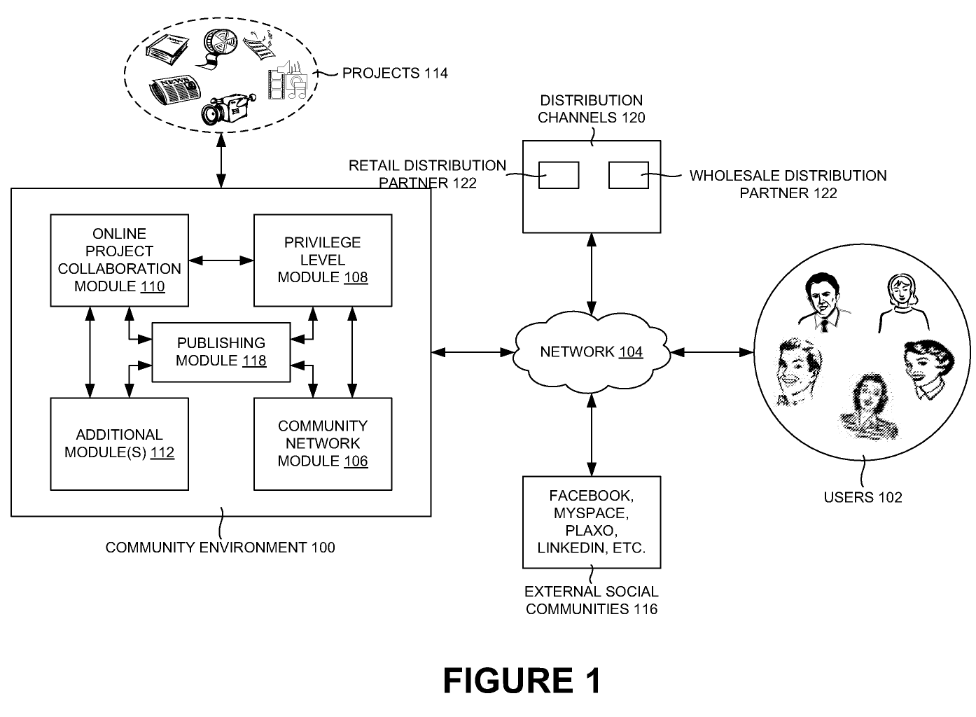

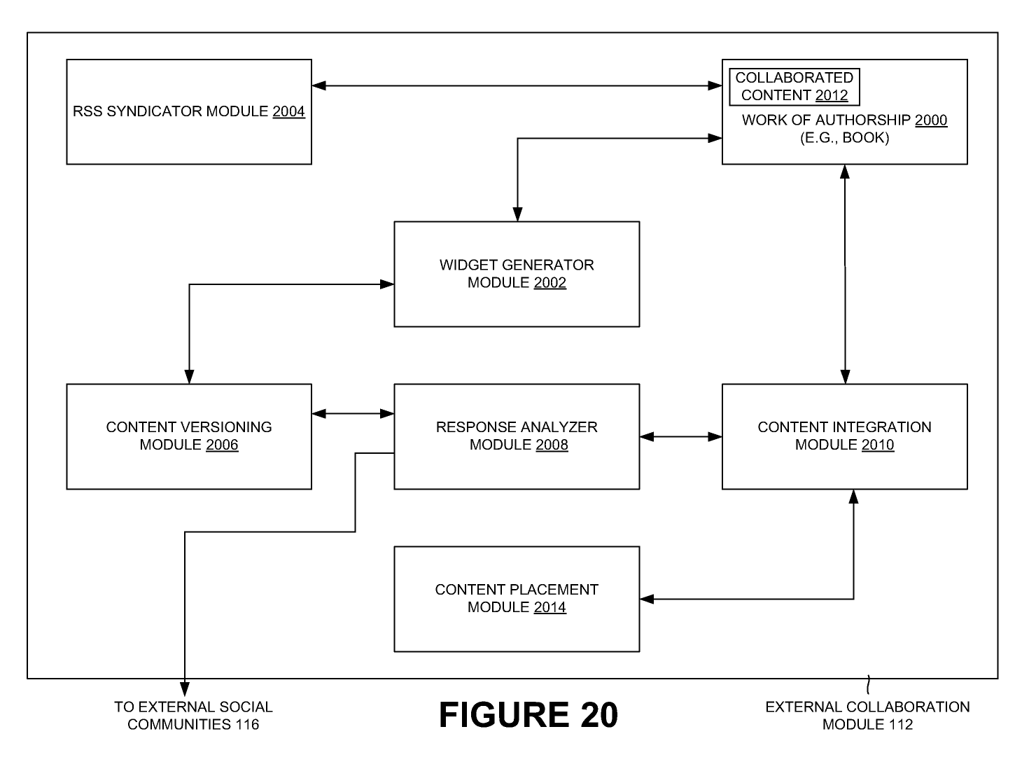

In one embodiment, a method includes building a work of authorship (e.g., the work of authorship 2000 of FIG. 20) through a collective coordination of authors of the work of authorship in a community environment (e.g., the community environment 100 of FIG. 1), providing a portion of content of the work of authorship on an external social community (e.g., the external social community 116 of FIG. 1) through a feed from the community environment 100 to the external social community 116, processing a response of a user (e.g., the user 102 of FIG. 1) of the external social community 116 in contributing to the work of authorship 2000, and integrating the response of the user 102 of the external social community 116 in the work of authorship 2000.

In another embodiment, a method includes creating a work of authorship (e.g., the work of authorship 2000 of FIG. 20) through a collective contribution of content by members of a community environment (e.g., the community environment 100 of FIG. 1) and users (e.g., the user 102 of FIG. 1) of an external social community (e.g., the external social community 116 of FIG. 1), placing content in predetermined sections of a template embodying a preferred style based on a category of the work of authorship 2000, and printing the work of authorship 2000 based on a set of orders received through distribution partner associated with the work of authorship 2000.

In yet another embodiment, a system includes a community environment (e.g., the community environment 100 of FIG. 1) having a suite of services that enable an author to collaborate with other authors in the community environment 100 in writing, producing, formatting, designing and publishing a work of authorship (e.g., the work of authorship 2000 of FIG. 20), a network (e.g., the network 104 of FIG. 1), and a set of external social communities (e.g., the external social communities 116 of FIG. 1) associated with the author that publish a snippet of the authorship in the external social communities 116 such that the snippet enables contribution to the work of authorship 2000 by users 102 of the external social community 116.

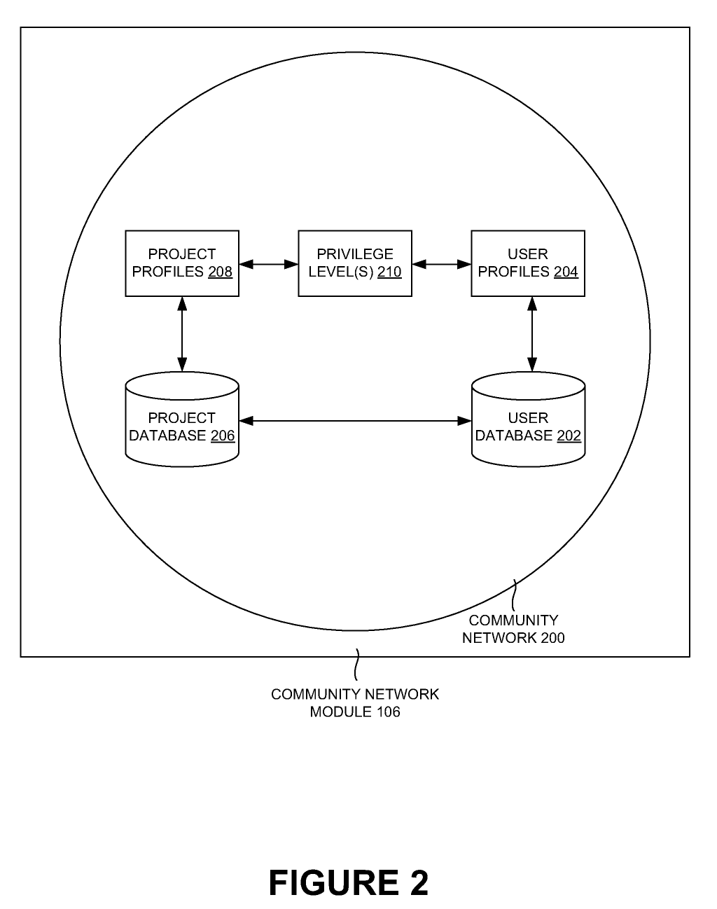

FIG. 1 is a system view of a community environment 100 enabling an online project collaboration between user profiles (e.g., the user profiles 204 of FIG. 2) and project profiles (e.g., the project profiles 208 of FIG. 2), according to one embodiment. Particularly, FIG. 1 illustrates the community environment 100, users 102, a network 104, a community network module 106, a privilege level module 108, an online project collaboration module 110, an external collaboration module 112, projects 114, an external social communities 116, a publishing module 118, distribution channels 120, a retail distribution partner 122, and a wholesale distribution partner 124 according to one embodiment.

The community environment 100 may enable creation of a community network (e.g., the community network 200 of FIG. 2) where an online community of users 102 (e.g., writers, editors and/or contributors, etc.) associated with the user profiles 204 collaborate to complete the projects 114 associated with the project profiles 208. For example, writers and editors may make their creative dreams a reality with the help of contributors and/or coeditors. For example, the contributors and the coeditors may be users 102 having interest in a project (e.g., of the projects 114 of FIG. 1) and willing to contribute for the project 114.

The users 102 may include registered users and/or unregistered users of the community environment 100. The registered users may be members having user profiles 204 in the community network 200. For example, the user profiles 204 may include information such as a name, address, contact information (e.g., phone number, email address, etc.), picture, and/or other biographical information (e.g., interests, contributions, life history, etc.). In one example embodiment, the unregistered users may be enabled to view and/or read the project profiles 208 whereas the registered users may be enabled to edit (e.g., update, modify and/or delete, etc.) content associated with the project profiles 208.

The network 104 may facilitate communication between the users 102 and the community environment 100. The community network module 106 may generate the community network 200 that includes the user profiles 204 and the project profiles 208 in the community environment 100. In one example embodiment, the project profiles 208 may be associated with the user profiles 204 and the projects 114. For example, the users 102 of the community environment 100 may form the community network 200 based on an online collaboration between the user profiles 204 and the project profiles 208.

The privilege level module 108 may designate privilege level(s) (e.g., the privilege level(s) 210 of FIG. 2) associated with a project profile 208 (e.g., associated with a user profile 204) to other user profiles 204 in the community network 200 based on interests specified in the other user profiles 204. For example, the privilege levels 210 may include role-based privilege levels (e.g., reader, contributor, and/or editor, etc.), a project-based privilege level (e.g., public or private, etc.) and/or a profile-based privilege level (e.g., prohibited user profile level).

The online project collaboration module 110 may generate an online project collaboration between the user profiles 204 and the projects 114 of the project profiles 208. For example, the online project collaboration may include contributing material, editing content, a discussion (e.g., discussion writing) and/or commenting associated with the project 114.

The extra collaboration module 112 may enable the communication between external social communities (e.g., Facebook®, MySpace®, Plaxo®, etc.). The projects 114 may include a book, a magazine, audio books, an advertising copy, a screenplay, a periodical, music, video, and/or music sound files which are further classified into sections, chapters, cited material and/or quoted material. For example, each project profile 208 may include a portion of project 114 which is completed based on the online collaboration of the users 102 based on the privilege level(s) 210 associated with each user 102. The external social communities 116 may be social communities (e.g., Facebook®, MySpace®, Plaxo®, etc.) in which the author may have a profile. The publishing module 118 may enable the author to publish his works (e.g., literary works, etc.). The distribution channels 120 may be patrons who are ready distribute the work of the author. The distribution channels 120 may be methods, processes, infrastructure, institutions and/or pricing mechanisms required to bring a product from manufacturers to consumers. The retail distribution partner 122 may market, trade, etc. the work (e.g., the literary work, etc.) of the author in retail centers (e.g., sale of goods or merchandise from a fixed location, such as a physical storefront, through an Internet ecommerce site, and/or through kiosk, or by post, in small or individual lots for direct consumption by a purchaser). The wholesale distribution partner 124 (e.g., a reseller of new and used goods to retailers) of the author may distribute the work of authorship to other markets and resellers.

For example, a project (e.g., of the projects 114 of FIG. 1) may be associated with a first user (e.g., of the users 102 of FIG. 1) having a user profile (e.g., of the user profiles 204 of FIG. 2). The first user 102 may invite other users 102 (e.g., associated with user profiles 204 in the community network 200) to contribute to the project 114 and may assign different privilege level(s) 210 based on interests of the other users 102. Further, the other users 102 may edit (e.g., modify, delete, etc.) content, post comments regarding the project 114 based on the privilege levels 210 assigned to each of the users 102. For example, a user may be allowed to post comments to the project 114 while another user may modify the content associated with the project 114 based on the assigned privilege level(s) 210. As a result, the first user 102 may complete the project 114 through contributions of the other users 102.

In the example embodiment illustrated in FIG. 1, the community environment 100 communicates with the users 102 through the network 104 (e.g., Internet). The community environment 100 also communicates with the projects 114 of the project profiles 208 associated with the user profiles 204. The community environment 100 includes the community network module 106, the privilege level module 108, the online project collaboration module 110 and the additional modules 112, interacting with each other.

In one embodiment, a first instruction set may enable a community network 200, to include a user database 202 to include user profiles 204 and a project database 206 to include project profiles 208, each project profile 208 associated with a user profile 204 and a project 114. Further, a second instruction set integrated with the first instruction set may generate privilege levels 210 associated with the user profiles 204 and the project profiles 208.

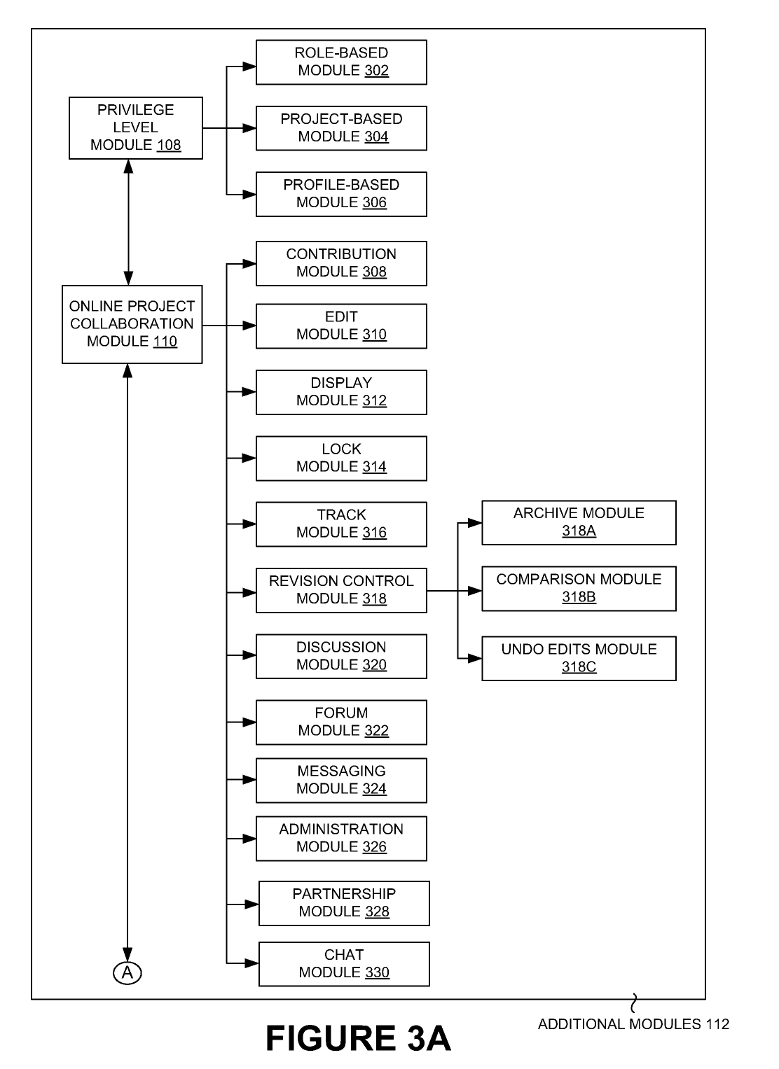

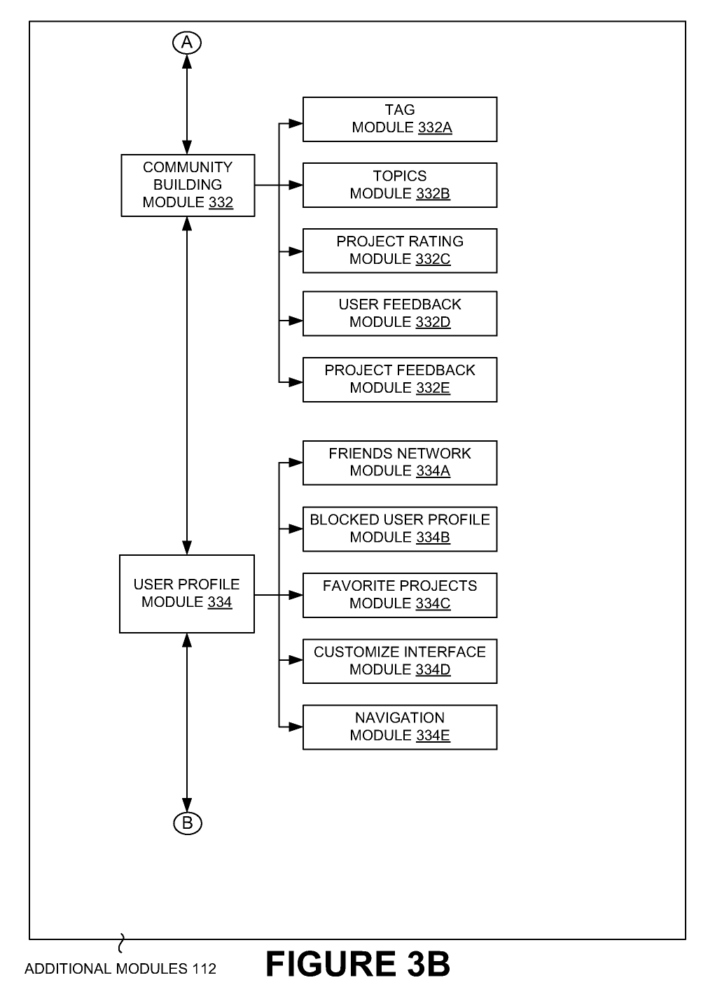

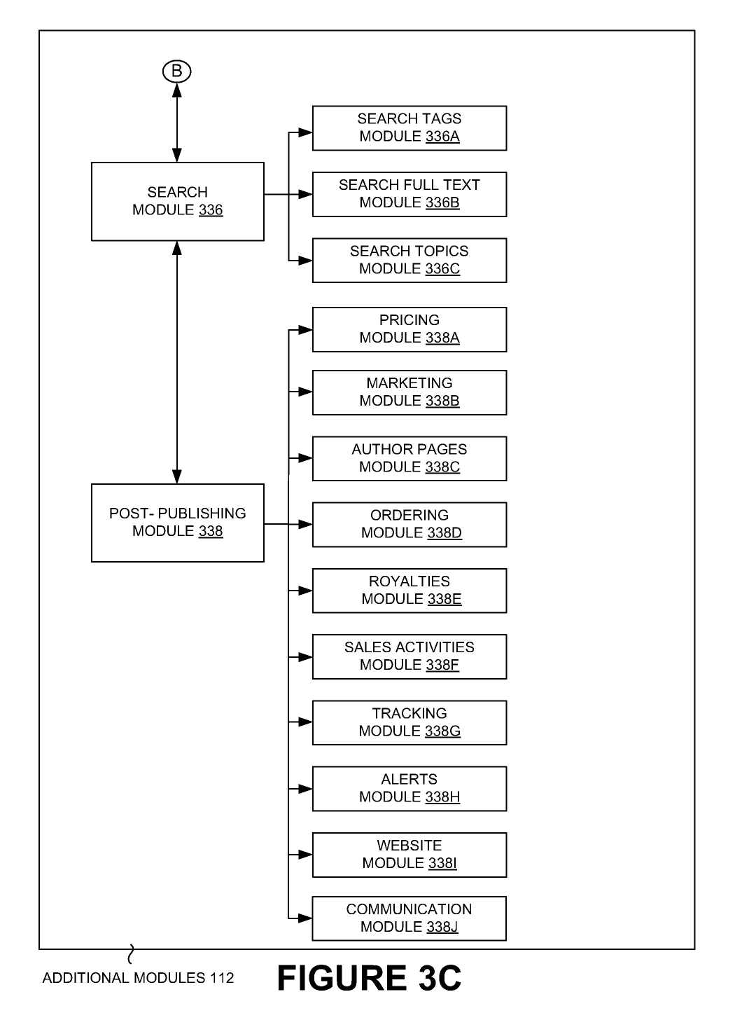

In addition, a third instruction set integrated with the first instruction set and the second instruction set may generate an online collaboration (e.g., using the online project collaboration module 110 of FIG. 1) between a user profile 204 and a project 114 of a project profile 208. A fourth instruction set integrated with the first instruction set, the second instruction set and the third instruction set may generate a display (e.g., using the display module 312 of FIG. 3A) associated with the online collaboration, the user profile 204, the project profile 208 and/or the project 114.

In another embodiment, the community environment 100 may have a suite of services that enable an author to collaborate with other authors in the community environment 100 in writing, producing, formatting, designing and/or publishing a work of authorship (e.g., the work of authorship 2000 of FIG. 20).

FIG. 2 is an exploded view of the community network module 106 of FIG. 1, according to one embodiment. Particularly, FIG. 2 illustrates the community network module 106, a community network 200, a user database 202, user profiles 204, a project database 206, project profiles 208 and privilege level(s) 210, according to one embodiment.

The community network 200 may be a network formed by association of the users 102 having the user profiles 204 in the community environment 100. For example, the users 102 may include writers, editors, contributors, readers, coeditors, etc. The user database 202 may include the user profiles 204 associated with the users 102 of the community network 200. The user profiles 204 may contain profile information associated with the users 102 of the community network 200. For example, the profile information may include a name, picture, profile history, interests, contributions, ratings, etc.

The project database 206 may include the projects 114 of the project profiles 208 associated with the user profiles 204. In one example embodiment, each project profile may be associated with one or more one user profiles 204 and a project 114. For example, the project 114 may be an uncompleted portion of a project profile 208, associated with a user profile 204, which has been completed by working together with other users 102 of the community network 200.

The project profiles 208 may be wooks (e.g., books, magazines, periodicals, etc.) having the projects 114 (e.g., uncompleted chapters, topics, subtopics, and/or other content) that are to be completed by taking considerations of other users 102 of the community network 200. The privilege levels 210 may be rights or permissions granted to the users 102 associated with user profiles 204 regarding the projects 114 associated with the project profiles 208. In one example embodiment, the users 102 may access a particular project 114 associated with a project profile 208 based on the privilege level(s) 210 assigned to the users 102.

In the example embodiment illustrated in FIG. 2, the community network module 106 may generate the community network 200 which includes the user database 202, the user profiles 204, the project database 206, the project profiles 208 and the privilege levels 210. The user database 202 containing the user profiles 204 communicates with the project database 206 containing the project profiles 208. The privilege level(s) 210 communicates with the user profiles 204 and the project profiles 208.

In one embodiment, the user profiles 204 may be generated (e.g., using the user database 202 of FIG. 2). The project profiles 208 may be generated (e.g., using the project database 206 of FIG. 2), each project profile 208 associated with a user profile 204.

FIG. 3 is an exploded view of the additional modules 112 of FIG. 1, according to one embodiment. Particularly, FIG. 3A illustrates the privilege level module 108, the online project collaboration module 110, a role-based module 302, a project-based module 304, a profile-based module 306, a contribution module 308, an edit module 310, a display module 312, a lock module 314, a track module 316, a revision control module 318, an archive module 318A, a comparison module 318B, an undo edits module 318C, a discussion module 320, a forum module 322, a messaging module 324, an administration module 326, a partnership module 328 and a chat module 330, according to one embodiment.

The role-based module 302 may designate role-based privilege levels associated with the projects 114 to the users 102. For example, each user 102 may be assigned one or more role-based privilege levels (e.g., a reader level, a contributor level, an editor level, and/or a coeditor level, etc.) to access the project profiles 208 which are not accessed by all.

The project-based module 304 may designate a project-based privilege level such as a public level, a private level, and/or a prohibited content level associated with the project profiles 208. For example, publicly available projects 114 may be viewed by all the users 102 of the community environment 100 where as private projects 114 may be viewed by the members (e.g., registered users) of the community network 200. In addition, prohibited content level may restrict access to certain portion of the project 114.

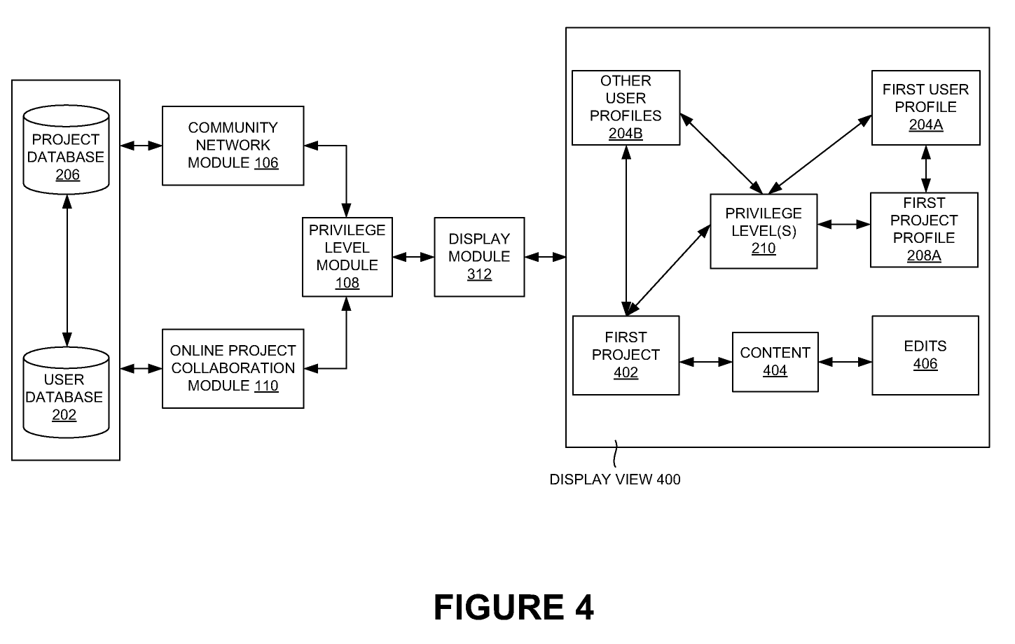

The profile-based module 306 may designate a profile-based privilege level such as a prohibited user profile level to the users 102 of the community environment 100. For example, the user 102 (e.g., writer, editor, author, etc.) of the project 114 may restrict access associated with the project 114 to other user profiles (e.g., the other user profiles 204B of FIG. 4) if the interests associated with the other user profiles 204B does not match with the requirements of the project 114.

The contribution module 308 may enable contribution of material from the other user profiles 204B of the community network 200 based on an online project collaboration between the project profile 208 and the other user profiles 204B. The contributors can write, edit, research some stuff about the project 114, generate feedbacks and/or post comments regarding the project 114.

The edit module 310 may enable the user 102 to edit content (e.g., the content 404 of FIG. 4) associated the project 114 associated with the project profile 208. For example, the edits (e.g., the edits 406 of FIG. 4) may be highlighted in different colors (e.g., may appear in yellow, green, red, etc.) in order to identify the changes made to an original version.

The display module 312 may display a portion of the project 114 associated with the project profile 208. For example, the display module may generate a display view (e.g., the display view 400 of FIG. 4) that includes the privilege level(s) 210 associated with the project 114 and the user profiles 204. Further, the portion of the project 114 may be displayed to other users 102 according to a predetermined structure based on search associated with the project 114.

The lock module 314 may lock a portion of the project 114 associated with the project profile 208. For example, the user 102 (e.g., editor, author, etc.) may lock certain amount of data associated with the project 114 prior to assigning the privilege level(s) 210 to the other user profiles 204B. As a result, the user 102 may retrieve original project 114 if the edits 406 made by the other user profiles 204B are not pertinent.

The track module 316 may track (e.g., identify, process, manage and/or store) information associated with the contributed material of the project 114 and provide control over edits (e.g., the edits 406 of FIG. 4) made by the other users 102 (e.g., contributors, coeditors, etc.) to the user 102 (e.g., writer, editor, author, etc.). For example, the user 102 (e.g., writer, editor, author, etc.) may keep updates of the edits 406 made by other contributors to the content 404 of the project 114 in order to identify differences between the original version and the modified version.

The revision control module 318 may control revisions to the project 114. For example, multiple revisions and/or changes made to documents of the same project 114 by different users 102 (e.g., writer, editor, author, co-editor, contributor, etc.) may be managed using the revision control module 318. In one example embodiment, the archive module 318A may archive one or more versions of the project 114. For example, the current version and one or more modified versions of the project 114 may be stored on the project website.

The comparison module 318B may display the one or more versions of the project 114 and identify differences between the current version and the previous version of the project 114. For example, the user 102 (e.g., writer, editor, author, etc.) may distinguish between his/her version and the modified version of the contributors in order to finalize or freeze the project 114 by accepting or rejecting changes. The undo edits module 318C may generate a previous version of the project 114 by reversing the edits 406 to the current version of the project 114. For example, the user 102 may retrieve original version if the edits 406 made by the other user profiles 204B to the original version are not relevant.

The discussion module 320 may enable a discussion associated with a user profile 204 and a project profile 208. For example, the discussion may be a website where the user 102 associated with user profile 204 may post informal journals of their thoughts, comments, and/or philosophies, which are updated frequently. For example, the user 102 (e.g., contributors, readers, etc.) may share his/her thoughts associated with the project 114 by posting content associated with the project 114 in an interactive format on the project webpage.

The forum module 322 may generate a forum to display comments associated with the user profiles 204 and the project profiles 208. For example, the forum may be a web application for carrying out discussion and/or posting user generated content related to the project 114 by the users 102 of the community network 200. The messaging module 324 may process correspondences between the user profiles 204. For example, during the online project collaboration, the users 102 (e.g., contributor, editor, coeditor, reader, writer, author, etc.) may send open messages regarding the project 114 and also share their thoughts by suggesting improvements in the project 114.

The administration module 326 may manage the online project collaboration which includes managing forums (e.g., adding forums, removing forums), system tags (e.g., through making, accepting additions to tag lists, etc.), project genres (e.g., through modifying genre list, moving projects between genres, etc.) The managing of the online collaboration may include editing (e.g., deleting, modifying, etc.) inappropriate content, and/or content marked as liability risk and/or blocking users and/or content associated with the liability risk. The administration module 326 may enable creation of new users, adding information to a user's profile, resetting of login name and password, assigning rights to the users (e.g., associated with projects), etc. In addition, the administration module 326 may manage financial activities associated with the online project collaboration such as purchasing projects, royalties, etc. The administration module 326 may also track workflow associated with a project during the online project collaboration.

The partnership module 328 may build bidirectional links (e.g., to transfer data) between the users associated with the online project collaboration and/or link partner content (e.g., favorite content). The partnership module 328 may enable organizations to build sub-communities (or sub-domains) within applications to provide targeted solutions for corporate users through a repurposed model and/or place an application appearance around a partner application's functionality through a co-branding model. The partnership module 328 may also enable branded and/or co-branded reading, writing, retailing and/or distribution of the projects. In addition, the partnership module 328 may track (e.g., to credit/debit partners) the links through reporting partner activities. The partnership module 328 may further aggregate identities through contacts, social networks, etc. The chat module 330 may generate a chat room which enables instant online communication between the users 102 regarding the project 114.

Particularly, FIG. 3B illustrates a community building module 332, a tag module 332A, a topics module 332B, a project rating module 332C, a user feedback module 332D, a project feedback module 332E, a user profile module 334, a friends network module 334A, a blocked user profile module 334B, a favorite projects module 334C, a customize interface module 334D and a navigation module 334E, according to one embodiment.

The community building module 332 may generate community building activities. For example, the community building activities may include generating topics, generating tags, rating users, rating project and generating feedback associated with the user profile 204 and/or project profile 208.

The tag module 332A may generate tags associated with interest categories. For example, a tag may be a keyword or a term contains information (e.g., picture, article, video clip, book, etc.) about the project 114 and is used in indexing. In one example embodiment, each project 114 may be associated with different tags that are classified based on interest categories.

The topics module 332B may generate topics associated with the project profile 208. For example, a topic may be a title associated with each project 114 of the project profile 208 indicating genre of the project 114.

The project rating module 332C may rate the project 114 associated with the project profile 208. For example, the users 102 (e.g., contributors, readers, other users, etc.) may rate the project 114 based on the quality and/or other features associated with the project 114. The user feedback module 332D may generate feedback related to the user 102 associated with the user profile 204 regarding the edits 406 in the project 114.

For example, the edit 406 made by the contributors to the project 114 may either be accepted or declined by user 102 (e.g., writer, editor, author, etc.) depending on the validity of the edits 406 associated with the project 114. The project feedback module 332E may generate feedback related to the project 114 associated with the project profile 208. For example, the contributors may share their ideas regarding the project 114 by giving feedback to the user 102 associated with the project 114. The feedback for the project 114 may be useful to improve the quality of the project 114.

The user profile module 334 may personalize the user profiles 204. For example, the personalizing the user profiles 204 may include managing and/or controlling the information associated with the user profile 204. The friends network module 334A may associate a user profile (e.g., of the user profiles 204 of FIG. 2) with the user profile 204 and enable communication between the two user profiles 204. For example, the user 102 (e.g., writer, editor, author, etc.) may personalize his/her user profile 204 by associating with other user profiles 204 to create a friends network.

The blocked user profile module 334B may block one or more user profiles 204. For example, the user 102 (e.g., writer, editor, author, etc.) may invite certain users to contribute for the project 114 and block the other users based on the interest level associated with each user profile 204.

The favorite projects module 334C may generate a list of favorite projects. In one example embodiment, each favorite project may be associated with a project profile 208. For example, the user 102 (e.g., contributor, editor, writer, author, etc.) may list his favorite projects depending on an interest level and the level of contributions made by him to the projects 114.

The customize interface module 334D may manage colors and/or font styles associated with the user profiles 204 and/or project profiles 208 of the community environment 100. For example, the user 102 (e.g., writer, editor, author) may customize his webpage (e.g., displayed to others users) according to his/her wish and/or requirements. The navigation module 334E may control a location of a navigation item associated with the user profile 204 and/or the project profile 208. For example, the user 102 (e.g., writer, editor, author) may apply thoughts, plans, direct, record, and/or control the project 114 according to a predetermined structure.

In accordance with one example embodiment, community building activities may be generated (e.g., using the community building module 332 of FIG. 3B). Tags associated with interest categories may be generated (e.g., using the tag module 332A of FIG. 3B). Topics associated with the project profiles 208 may be generated (e.g., using the topics module 332B of FIG. 3B).

The project 114 associated with the project profile 208 may be rated (e.g., using the project rating module 332C of FIG. 3B). Further, the feedback related to the user 102 associated with the user profile 204 may be generated (e.g., using the user feedback module 332D of FIG. 3B).

Also, the feedback related to the project 114 associated with the project profile 208 may be generated (e.g., using the project feedback module 332E of FIG. 3B). The first user profile 204A may be personalized (e.g., using the user profile module 334 of FIG. 3B). A user profile 204 may be associated with the first user profile 204A to create a friends network (e.g., using the friends network module 334A of FIG. 3B).

The user profile 204 of the user profiles 204 may be blocked (e.g., using the blocked user profile module 334B of FIG. 3B). Further, the list of favorite projects associated with the user profile 204 may be generated (e.g., using the favorite projects module 334C of FIG. 3B), each favorite project associated with a corresponding project profile.

In addition, colors and font styles of the community environment 100 may be managed (e.g., using the customize interface module 334D of FIG. 3B). The location of a navigational item associated with the first user profile 204A and/or the first project profile 208A may be controlled (e.g., using the navigation module 334E of FIG. 3B).

Particularly, FIG. 3C illustrates a search module 336, a search tags module 336A, a search full text module 336B, a search topics module 336C, a post-publishing module 338, a pricing module 338A, a marketing module 338B, an author pages module 338C, an ordering module 338D, a royalties module 338E, a sales activities module 338F, a tracking module 338G, an alerts module 338H, a website module 338I and a communication module 338J, according to one embodiment.

The search module 336 may generate a search associated with the user profiles 204 and the project profiles 208. For example, the user 102 (e.g., registered users and unregistered users) may search for the project profiles 208 based on his/her interests. The search tags module 336A may search tags associated with interest categories. For example, the user 102 may search for tags associated with information (e.g., a picture, article, a video clip, a book, etc) about the projects 114.

The search full text module 336B may search the user profiles 204 and/or the project profiles 208 in the full text mode. For example, the search full text module 336B may match all the search words provided by the user 102 associated with the user profile 204 with the required project. The search topics module 336C may search the project profiles 208 based on a topic (e.g., title, subtitle, etc.) and a genre (e.g., type, kind, etc.).

The post-publishing module 338 may generate post-publishing activities. For example, the post-publishing activities may include pricing, marketing, orders, royalties, sales, status, alert and/or notifications associated with completed project. In one example embodiment, the completed project may refer to a project collaborated by an online network or a project uploaded by an author without need for collaboration contributions (e.g., the project 114 that just needs to be published).

The pricing module 338A may generate a price related to the completed project 114 associated with the project profile 208. For example, the price of the completed project 114 may be varied based on the interest of the users 102 in that project 114 and/or ratings associated with the completed project 114. The marketing module 338B may determine marketing preferences associated with the completed project 114.

The author pages module 338C may generate customized author pages associated with the completed project 114. For example, the user 102 (e.g., writer, editor, author, etc.) may customize his/her webpage based on his/her requirements, preferences and/or specifications. The ordering module 338D may generate orders associated with the completed project 114. For example, generating orders may include either buying and/or selling the completed project 114 which has to be processed immediately in the current market.

The royalties module 338E may manage royalties associated with the completed project 114. For example, the royalties may correspond to proprietary rights associated with the completed project 114. For example, the user 102 (e.g., writer, editor, author) may sell their copyright to publishing media (e.g., periodical, website, etc.). The sales activities module 338F may manage sales activities associated with the completed project 114. For example, sales activities may include techniques to increase profits and/or sales.

The tracking module 338G may capture (e.g., store, record, track, etc.) information associated with a status of the completed project 114. The alerts module 338H may generate alerts and/or notifications associated with the completed project 114. For example, the alerts module 338H may notify the users 102 about the new projects 114 that are published in the website.

The website module 338I may generate a website to promote the completed project 114. In one example embodiment, the website may be dedicated to a particular topic and may be updated with the latest news, views and/or trends in order to provide publicity associated with the completed project 114. The communication module 338J may generate a communication associated with the completed project 114. For example, the communication may include buying, selling, viewing, etc. the completed project 114 by the users 102 of the community environment 100.

In accordance with one example embodiment, a post-publishing activity associated with a second project profile may be generated (e.g., using the post-publishing module 338 of FIG. 3C). A price related to a second project (e.g., the completed project) associated with the second project profile may be generated (e.g., using the pricing module 338A of FIG. 3C). Marketing preferences associated with the second project may be determined (e.g., using the marketing module 338B of FIG. 3C).

Also, customized author pages associated with the second project may be generated (e.g., using the author pages module 338C of FIG. 3C). Orders associated with the second project may be generated (e.g., using the ordering module 338D of FIG. 3C). Further, royalties associated with the second project may be managed (e.g., using the royalties module 338E of FIG. 3C). Sales activities associated with the second project may be managed (e.g., using the sales activities module 338F of FIG. 3C). A status associated with the second project may be tracked (e.g., using the tracking module 338G of FIG. 3C).

In addition, an alert and/or a notification associated with the second project may be generated (e.g., using the alerts module 338H of FIG. 3C). A website may be generated (e.g., using the website module 338I of FIG. 3C) to promote the second project. A communication associated with the second project may be generated (e.g., using the communication module 338J of FIG. 3C).

In the example embodiment illustrated in FIGS. 3A, 3B and 3C, the additional modules 112 includes the privilege level module 108, the online project collaboration module 110, the community building module 332, the user profile module 334, the search module 336 and the post publishing module 338 communicating with each other. In addition, the privilege level module 108 includes the role-based module 302, the project-based module 304 and the profile-based module 306. The online project collaboration module 110 includes the contribution module 308, the edit module 310, the display module 312, the lock module 314, the track module 316, the revision control module 318, the discussion module 320, the forum module 322, the messaging module 324, the administration module 326, the partnership module 328 and the chat module 330. Further, the revision control module 318 includes the archive module 318A, the comparison module 318B and the undo edits module 318C.

The community building module 332 includes the tag module 332A, the topics module 332B, the project rating module 332C, the user feedback module 332D and the project feedback module 332E. The user profile module 334 includes the friends network module 300A, the blocked user profile module 334B, the favorite projects module 334C, the customize interface module 334D and the navigation module 334E.

The search module 336 includes the search tags module 336A, the search full text module 336B and the search topics module 336C. The post publishing module 338 includes the pricing module 338A, the marketing module 338B, the author pages module 338C, the ordering module 338D, the royalties module 338E, the sales activities module 338F, the tracking module 338G, the alerts module 338H, the website module 338I and the communication module 338J.

FIG. 4 is a block diagram illustrating generation of a display view 400, according to one embodiment. Particularly, FIG. 4 illustrates the community network module 106, the privilege level module 108, the online project collaboration module 110, the user database 202, a first user profile 204A, other user profiles 204B, the project database 206, a first project profile 208A, the privilege level(s) 210, the display module 312, the display view 400, a first project 402, content 404 and edits 406, according to one embodiment.

The display view 400 may display the first project 402 associated with the first user profile 204A and the privilege level(s) 210 associated with the first project 402 assigned to the other user profiles 204B. In addition, the first project 402 may be associated with the first project profile 208A. The first project 402 may be a portion (e.g., chapter, topic and/or sub-topic) of the first project profile 208A (e.g., book, periodical, magazine, etc.) that needs contribution from the other users 102 of the community network 200.

In one example embodiment, a first user 102 (e.g., author of the first project 402) associated with the first user profile 204A may designate the privilege levels 210 (e.g., using the privilege level module 108) associated with the first project 402 to the other user profiles 204B. The privilege level(s) 210 may include a reader level, editor level and/or contributor level. For example, the reader may view the first project 402, contributor may contribute material to the first project 402 and editor may contribute material and/or finalize the first project 402.

The content 404 may include stuff (e.g., matter, body, material, etc.) associated with the first project 402. The edits 406 may represent data that is updated and/or modified by the other users 102 associated with the other user profiles 204B. For example, the edits 406 to the content 404 associated with the first project 402 may be highlighted in different color in order to differentiate from original version of the first project 402.

In the example embodiment illustrated in FIG. 4, the display view 400 includes the first user profile 204A, the other user profiles 204B, the first project profile 208A, the privilege level(s) 210, the first project 402, the content 404 and the edits 406 interacting with each other. The community network module 106 and the online project collaboration module 110 communicate with the user database 202, the project database 206 and the privilege level module 108. The display module 312 communicates with the privilege level module 108 and generates the display view 400 as illustrated in FIG. 4.

In one embodiment, a first user 102 may be associated with a first user profile 204A and a first project profile 208A. A privilege level 210 associated with a second user profile (e.g., of the other user profiles 204B of FIG. 4) may be designated (e.g., using the privilege level module 108 of FIG. 1). The privilege level(s) 210 may be role-based privilege levels (e.g., may be a reader level, a contributor level, an editor level, and/or a coeditor level), project-based privilege level (e.g., may be a public level, a private level, and/or a prohibited content level), and/or profile based privilege level (e.g., may be a prohibited user profile level).

An online project collaboration (e.g., may include interacting via a wiki) may be generated (e.g., using the online project collaboration module 110 of FIG. 1) between the first project profile 208A and the second user profile 204B based on the privilege level 210. Material may be contributed (e.g., using the contribution module 308 of FIG. 3A) to the first project 402 (e.g., may be a book, a magazine, audio books, an advertising copy, a screenplay, a periodical, music, video, and/or a music sound file) associated with the first project profile 208A.

A portion of the first project 402 (e.g., may include a section, a chapter, cited material, and/or quoted material) associated with the first project profile 208A may be edited (e.g., using the edit module 310 of FIG. 3A). The portion of the first project 402 may be displayed (e.g., using the display module 312 of FIG. 3A) according to a predetermined structure. The portion of the first project 402 associated with the first project profile 208A may be locked (e.g., using the lock module 314 of FIG. 3A).

In addition, information associated with the contributed material may be tracked (e.g., using the track module 316 of FIG. 3A). Revisions to the first project 402 may be controlled (e.g., using the revision control module 318 of FIG. 3A). One version of the first project 402 may be archived (e.g., using the archive module 318A of FIG. 3A). Further, two versions of the first project 402 may be displayed. Differences between the two versions of the first project 402 may be identified (e.g., using the comparison module 318B of FIG. 3A). As a result, a previous version of the first project 402 may be generated by reversing edits to a current version of the first project 402 (e.g., using the undo edits module 318C of FIG. 3A).

A discussion associated with a user profile and/or a project profile may be enabled (e.g., using the discussion module 320 of FIG. 3A). A forum may be generated (e.g., using the forum module 322 of FIG. 3A) to display comments associated with the user profiles 204 and the project profiles 208. Messaging associated with a portion of the user profiles 204 may be enabled (e.g., using the messaging module 324 of FIG. 3A). The online collaboration may be managed (e.g., using the administration module 326 of FIG. 3A). The partner-related activities may be managed (e.g., through the partnership module 328 of FIG. 3A). Chatting associated with the portion of the user profiles 204 may be enabled (e.g., using the chat module 330 of FIG. 3A).

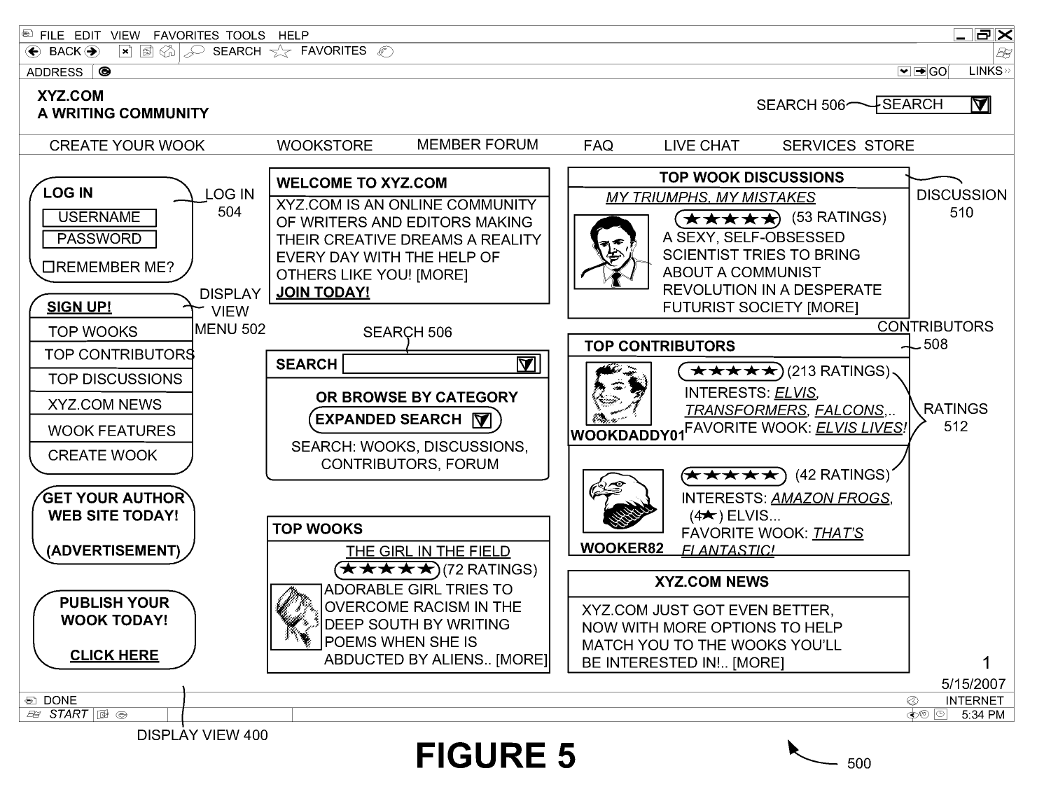

FIG. 5 is a user interface view 500 displaying a homepage associated with a website, according to one embodiment. Particularly, FIG. 5 illustrates a display view menu 502, a login option 504, a search option 506, contributors 508, a discussion 510, and ratings 512, according to one embodiment.

The display view menu 502 may provide different options through which the users 102 may view top wooks, top contributors, top discussions, news and/or other features associated with the wooks. The login option 504 may enable registered users to login into the website. In one example embodiment, the homepage associated with the users 102 may be displayed upon logging in to the website. Further, the unregistered users may register (e.g., create membership) in the website and become members of the community network 200 using sign up option (e.g., as illustrated in the display view menu 502).

The search option 506 may enable the users 102 (e.g., the registered users and the unregistered users) to browse the projects 114 associated with the project profiles 208. Further, the search option 506 may also include an expanded search option through which the users 102 may browse the projects 114 based on category such as wooks, discussions, contributors, forum, etc. In addition, the search option 506 may enable refinement of search results. For example, the search option 506 may enable users to select at least one category from available categories to filter within a search result set.

The contributors 508 may be individuals who have contributed material for a project (e.g., the first project 402 of FIG. 4) associated with a project profile (e.g., the first project profile 208A of FIG. 4). For example, contribution to the project 402 may include adding text, suggestions, and/or posting comments. The discussion 510 may be a wook (e.g., journal, magazine, periodical, audio books, an advertising copy, etc.) that is often updated (e.g., with the latest news, views and/or trends, etc.) and contains information that the writer (e.g., owner of the wook) may wish to share with other users 102 of the community environment 100.

The ratings 512 may indicate ratings associated with the user profiles 204 and/or the project profiles 208. For example, the ratings 512 associated with the user profiles 204 may be given based on a contribution level and/or interests of the users 102 whereas the ratings 512 associated with the project profiles 208 may be given based on quality, genre and/or other features of the projects 114.

In the example embodiment illustrated in FIG. 5, the user interface view 500 displays the homepage associated with the website (e.g., xyz.com). The users 102 having membership may login to the website using the login option 504. In one example embodiment, the users 102 may login to the website to browse projects (e.g., wooks), to contribute material to the interested projects and/or invite other users 102 to contribute for his/her project. The users 102 of the community environment 100 may browse the projects 114 based on category such as wooks, discussions, contributors, writers, interests, etc.

The homepage associated with the website may enable the unregistered users only to view the wooks associated with the user profiles 204 whereas the registered users may be allowed to edit content 404 associated with the wooks after logging into the website. The users 102 may edit the content 404 corresponding to the privilege level assigned to each user 102. In addition, the users 102 may view the contributors 508, ratings 512 associated with the contributors 508 and/or wooks, and/or discussions associated with the wooks corresponding to the search query.

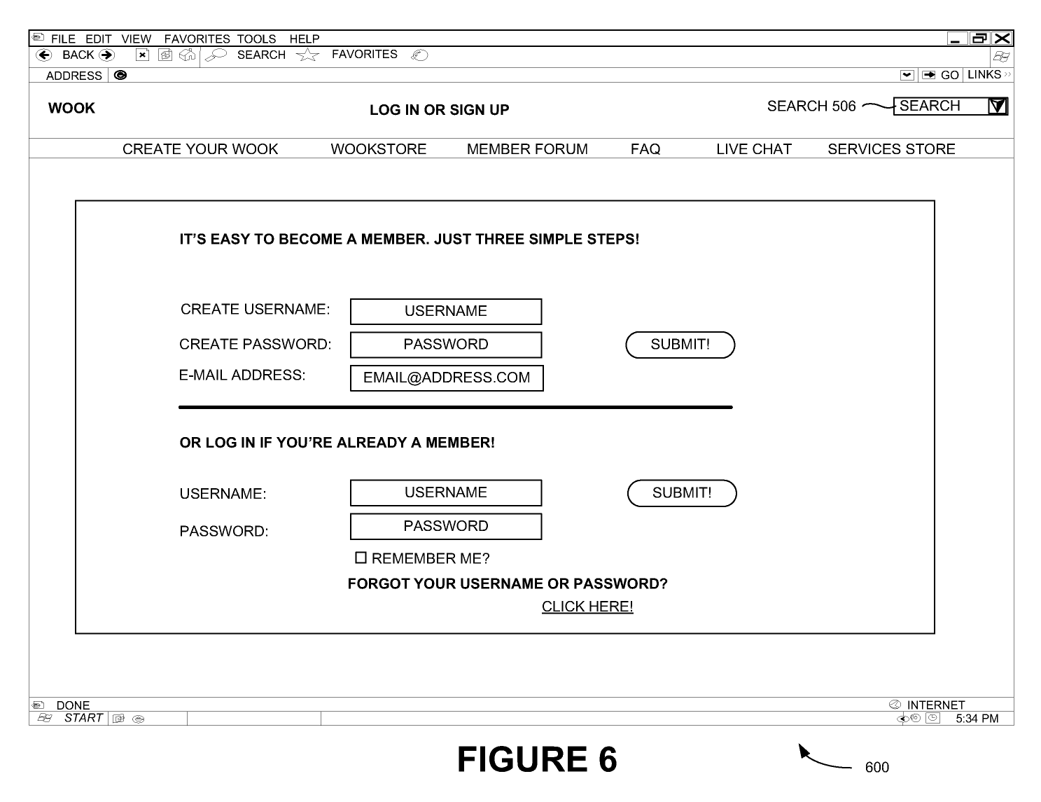

FIG. 6 is a user interface view 600 displaying a login and sign up page associated with the website, according to one embodiment. In one embodiment, unregistered users of the community environment 100 may create membership in the community network 200 by creating a new user name and password (e.g., using the create user name and create password option as illustrated). For example, the user name may be a screen name or a unique identifier associated with a user (e.g., of the users 102 of FIG. 1).

In addition, the user 102 has to specify a valid email address at the time of signing up. In one example embodiment, a confirmation of the membership of the user 102 may be sent to the specified email address upon sign up. In another embodiment, the registered users 102 (e.g., members of the community network 200) may login to the website using the corresponding user name and password.

In one example embodiment, the users 102 may login to the website to join online community of writers, editors and/or contributors who may share their thoughts to complete the project 114 and/or to publish the completed project 114 in the community network 200.

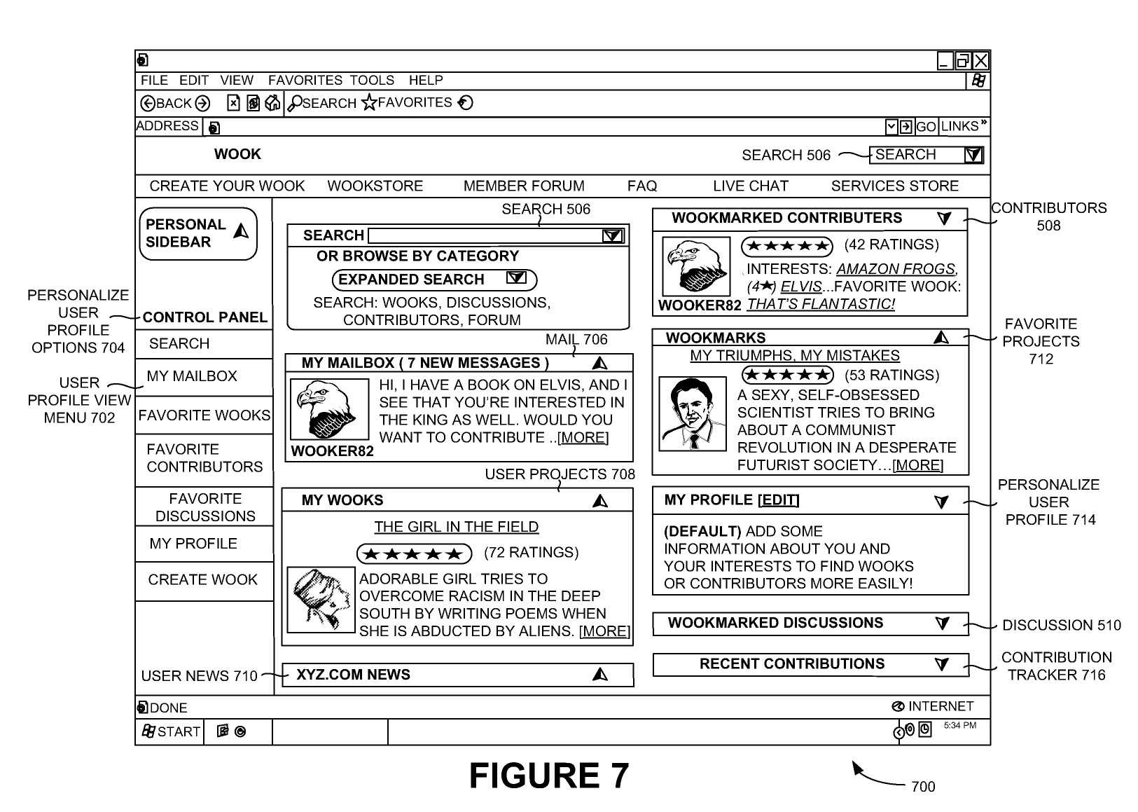

FIG. 7 is a user interface view 700 of a webpage associated with a user (e.g., of the users 102 of FIG. 1), according to one embodiment. Particularly, FIG. 7 illustrates the search option 506, the contributors 508, the discussion 510, a user profile view menu 702, personalize user profile options 704, a mail 706, user projects 708, user news option 710, favorite projects block 712, a personalize user profile option 714 and a contributions tracker 716, according to one embodiment.

The user profile view menu 702 may enable the user 102 to view information associated with his/her profile 204. For example, the information may include mails, favorite wooks, favorite contributors, favorite discussions, and profile information associated with the user 102 of the webpage. The personalize user profile options 704 may provide different options to the user 102 to personalize his/her profile 204. For example, personalizing the user profile 204 may include blocking user profiles (e.g., the user profiles 204 of FIG. 2), generating a list of favorite projects, managing colors and font styles of the community environment 100, and/or controlling a location of a navigational item associated with the user profile, etc.

The mail 706 may represent a message received from other users 102 of the community network 200 regarding the projects 114. The user projects 708 may represent projects (e.g., the projects 114 of FIG. 1) written by the user 102 and/or projects 114 to which the user 102 has contributed. The user news option 710 may provide latest information to the user 102 regarding the projects 114 that needs contribution and/or about the projects 114 that are published in the community network 200. The favorite projects block 712 may represent a list of favorite projects (e.g., of the projects 114 of FIG. 1) associated with the user 102 including ratings 512 associated with each project.

The personalize user profile option 714 may enable the user 102 to edit profile information associated with his/her profile. In one example embodiment, the user 102 may edit the profile to update personal information (e.g., interests, contributions, ratings) in order to find the projects 114 and/or the contributors 504 easily. The contributions tracker 716 may track (e.g., identify, process, manage and/or generate) recently contributed projects 114 associated with the user 102.

In the example embodiment illustrated in FIG. 7, the user interface view 700 displays the user profile 204 associated with the user 102. The user interface view 700 may enable the user 102 to browse the wooks through the search option 506. The personalize user profile options 704 may include a control panel through which the user 102 may personalize his/her profile. The user profile 204 may include wooks, contributors, wookmarks, wookmark discussions, recent contributions, etc. associated with the user 102.

The mail 706 may represent the mail received from another user ‘Wooker82’ of the community network 200. The mail displays information that Wooker82 is inviting the user 102 to contribute (e.g., share, comment, edit) to a book on Elvis. The user interface view 700 displays a wook ‘The Girl in the Field’ in the user projects 708, indicating the wook ‘The Girl in the Field’ is associated with the user 102.

The user interface view 700 also displays favorite projects of the user 102 as “My Triumphs, My Mistakes” and the ratings associated with “My Triumphs, My Mistakes” as “53” in the favorite projects block 712. Further, the user 102 may also edit his profile to update personal information (e.g., interests, contributions, etc.) which facilitates the user 102 to find wooks and/or contributors easily.

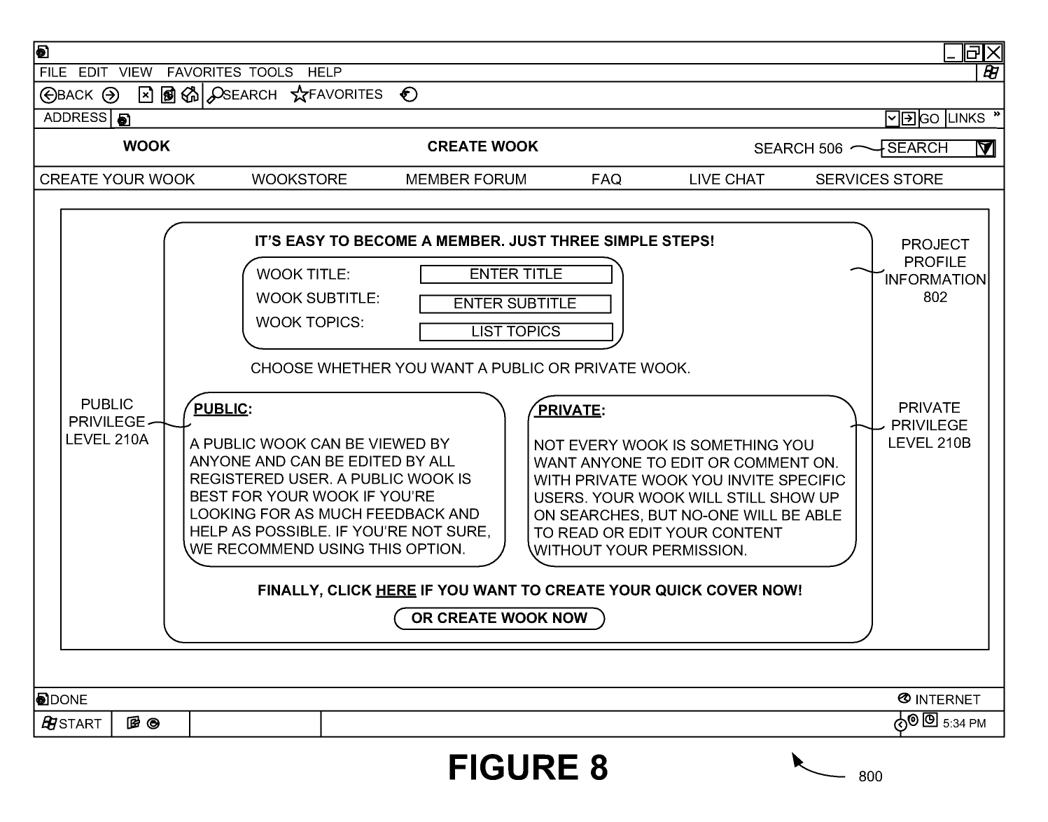

FIG. 8 is a user interface view 800 of creating the project profile 208, according to one embodiment. Particularly, FIG. 8 illustrates a public privilege level 210A, a private privilege level 210B and project profile information 802, according to one embodiment. The project profile information 802 may enable the user 102 (e.g., writer, editor, author, etc.) to update information (e.g., project title, project subtitle, list topics, etc.) associated with the project 114 while creating the project profile 208.

In the example embodiment illustrated in FIG. 8, the user interface view 800 displays a webpage of creating the project profile 208 by making use of the project profile information 802 provided by the user 102. In addition, the user 102 may assign a project-based privilege level (e.g., private, public, etc.) associated with the project profile 208. The public privilege level 210A may allow the users 102 (e.g., registered users and/or unregistered users) of the community environment 100 to view the project 114 and may be edited by all registered users of the community network 200.

The private privilege level 210B may enable only specific users (e.g., contributors) who are invited by the user 102 (e.g., writer, editor, author, etc.) to edit content 404 associated with the project 114, but the project 114 will still show based on search conducted by the other users 102, but no one will be able to read or edit the content 404. Furthermore, the user 102 may be permitted to create a quick cover related to the project 114 upon creating the project profile 208.

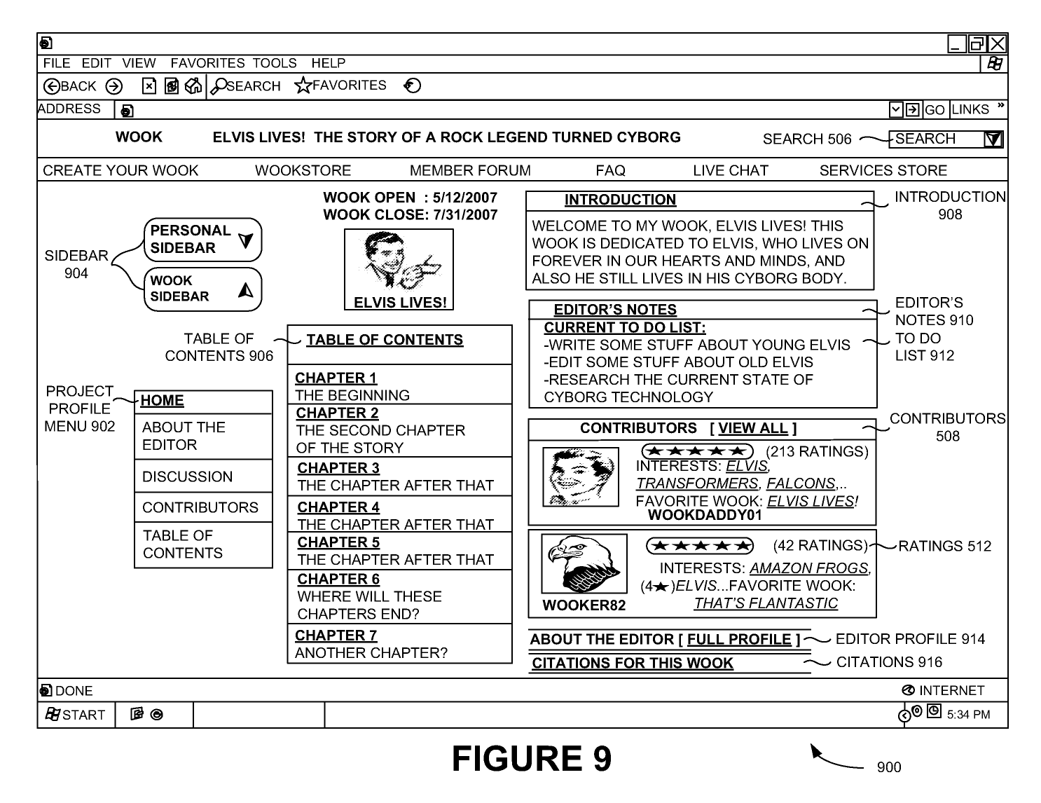

FIG. 9 is a user interface view 900 displaying a project profile (e.g., of the project profiles 208 of FIG. 2), according to one embodiment. Particularly, FIG. 9 illustrates the search option 506, the contributors 508, the ratings 512, a project profile menu 902, a sidebar 904, table of contents 906, an introduction block 908, editor's notes 910, to do list block 912, an editor profile option 914 and citations 916, according to one embodiment.

The project profile menu 902 may enable the user 102 to view details associated with the project profile 208. For example, the details may include information about editor, discussion, contributors, table of contents associated with the project profile 208. The sidebar 904 may be a block of text placed to the side of main text body in the project profile 208. The sidebar may include a personal sidebar and/or a wook sidebar. The personal sidebar may provide extra information about the user 102. The wook sidebar may provide extra information about the project profile's (e.g., wook) subject matter that is given prominence by means of a separate panel.

The table of contents 906 may display a list of chapters and topic associated with each chapter of the project profile 208. In one example embodiment, the user 102 may edit content (e.g., the content 404 of FIG. 4) associated with each chapter based on an editor's instructions (e.g., as illustrated in editor's notes 910). For example, if the editor has assigned a privilege level(s) 210 to edit content associated with chapter 2, then the user 102 may be able to edit only the content associated with chapter 2. In addition, a working outline may be included. In one embodiment, the working outline may include a tree view of the content section (or chapters) within a project that the editor or other user may use to increase and/or decrease indent level or ordinal value. The users with contributor rights may use the working outline to navigate between content sections within the book, view discussions dedicated to the content sections, and/or view summary level descriptions of the content sections when the content section is selected from within the outline.

The introduction block 908 may display a brief introduction about the project profile 208 (e.g., wook). For example, the introduction may give basic information such as genre of the wook, purpose of the wook, etc. The editor's notes 910 may display information posted by the editor of the project profile 208 (e.g., the wook) regarding incomplete work associated with the project (e.g., chapter, topic, etc.) of the project profile 208. Further, the user 102 may be assigned the privilege levels 210 associated with the project 114 based on his interest in that particular project.

The to do list block 912 may display content posted by the editor (e.g., author) of the project profile 208 regarding work to be done by the user 102 to the project 114 associated with the project profile 208. The editor profile option 914 may display profile information associated with the editor of the project profile 208. The citations 916 may be information needed to identify and/or to locate a project 114 quickly and efficiently in the community network 200. For example, a book citation may include author, title, publisher and/or year of publication while a journal citation includes author, article title and periodical title, date, volume and page numbers.

In the example embodiment illustrated in FIG. 9, the user interface view 900 displays the project profile 208. The project profile 208 may correspond to a wook (e.g., Elvis Lives). For example, the wook ‘Elvis Lives’ may be displayed to the user 102 upon accepting the invitation sent by the editor (e.g., as illustrated in the mail 706 of FIG. 7), requesting to contribute for the book on Elvis. Further, the profile information (e.g., author, contributor, contents, discussions, etc.) associated with Elvis Lives may be accessed by the user 102 using the project profile menu 902.

The table of contents 906 displays the chapter number and name of the topic associated with each chapter of the Elvis Lives. In addition, the editor's notes may indicate a portion of the Elvis Lives to be edited by the user 102 in the to do list block 912. The to do list block 912 displays “write some stuff about young Elvis, Edit Some stuff about old Elvis and research the current state of cyborg technology” indicating an amount of contribution required associated with Elvis Lives.

The contributors 508 may be contributors associated with Elvis Lives. For example, the contributors 508 may display the contributors “WookDaddy01” and “Wooker82” having 213 and 42 ratings respectively. The user 102 may also view information associated with the editor of Elvis Lives using the editor profile option 914.

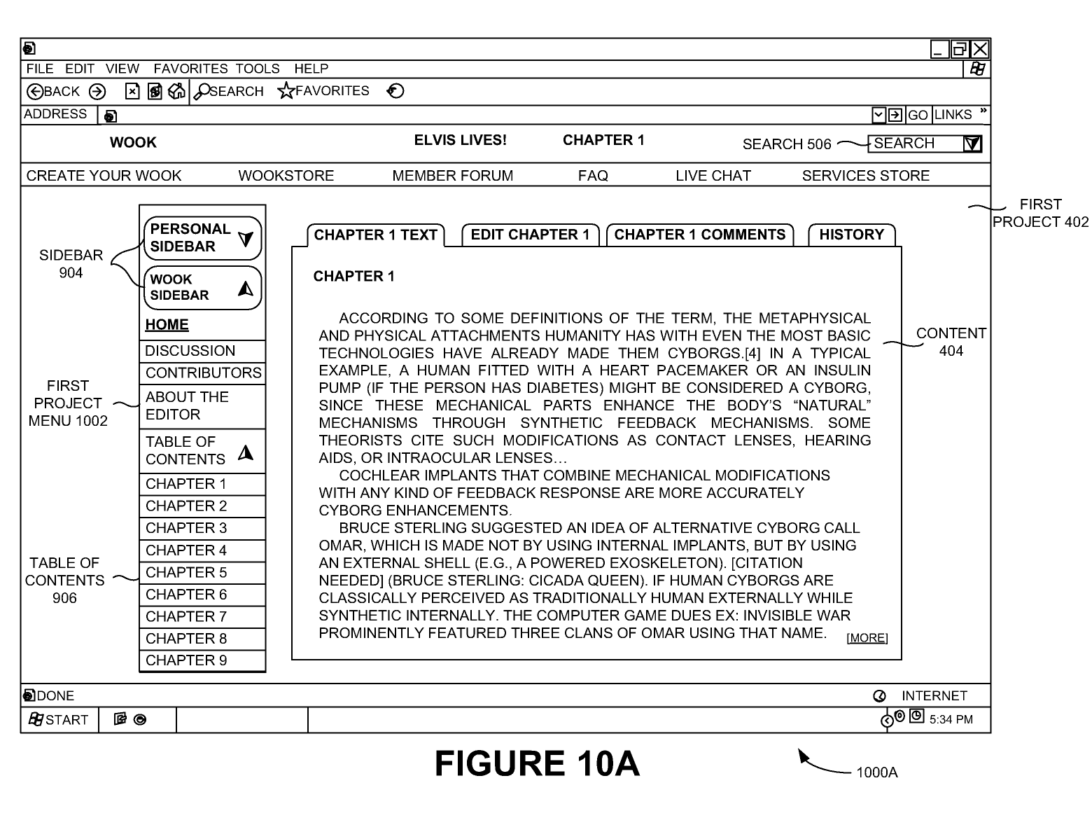

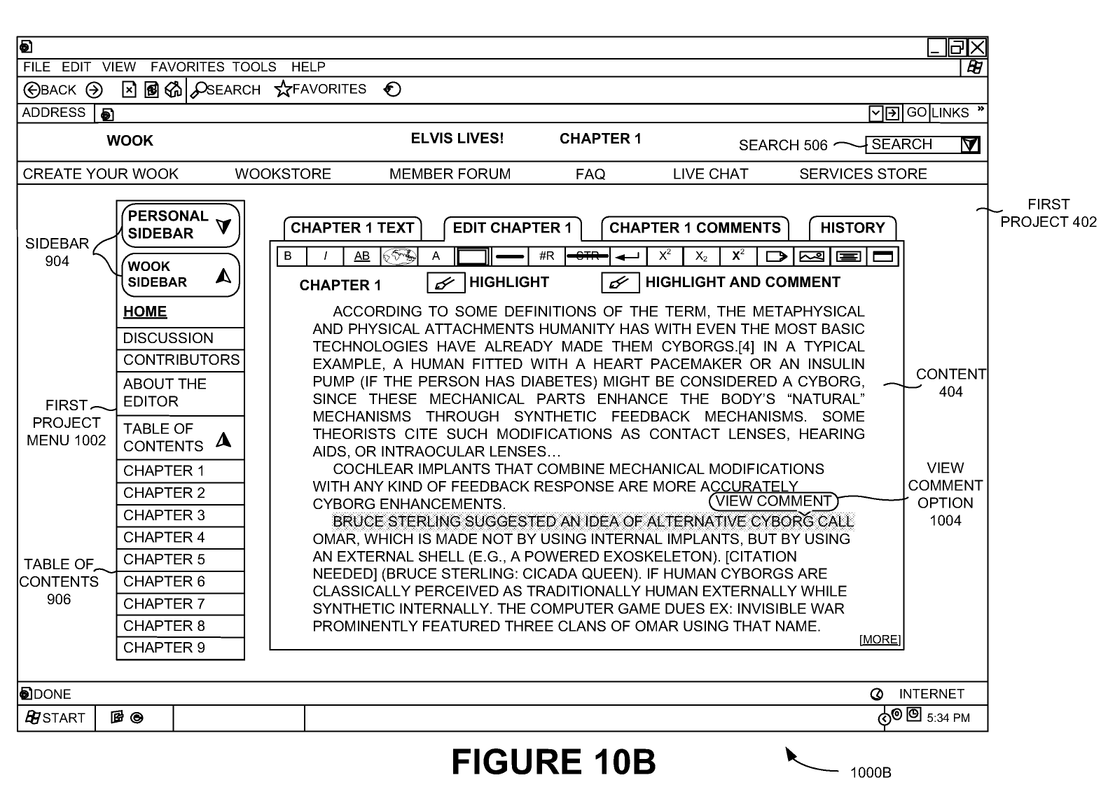

FIG. 10A is a user interface view 1000A of showing the content 404 associated with the first project 402 of the project profile 208, according to one embodiment. Particularly, FIG. 10A illustrates the first project 402, the content 404, the search option 506, the sidebar 904, the table of contents 906 and a first project menu 1002, according to one embodiment.

The first project menu 1002 may enable the user 102 to view details associated with the first project 402. For example, the details may include information about editor, discussion, contributors, table of contents associated with the first project. Further, the user 102 may select anyone of the chapters from the table of contents 906 using the first project menu 1002.

In the example embodiment illustrated in FIG. 10A, the user 102 has selected chapter 1 from the number of chapters displayed in the table of contents 906. As a result, the content 404 associated with chapter 1 may be displayed to the user 102. Further, the user 102 may edit the content 404 associated with chapter 1 based on a privilege level(s) 210 designated to the user 102. In one example embodiment, the privilege level(s) 210 may be assigned based on the user's interest in that project and/or ratings 512 associated with the user 102.

FIG. 10B is a user interface view 1000B of editing the content 404 associated with the first project 402 of the project profile 208, according to one embodiment. Particularly, FIG. 10A illustrates the first project 402, the content 404, the search option 506, the sidebar 904, the table of contents 906, the first project menu 1002 and a view comment option 1004 according to one embodiment.

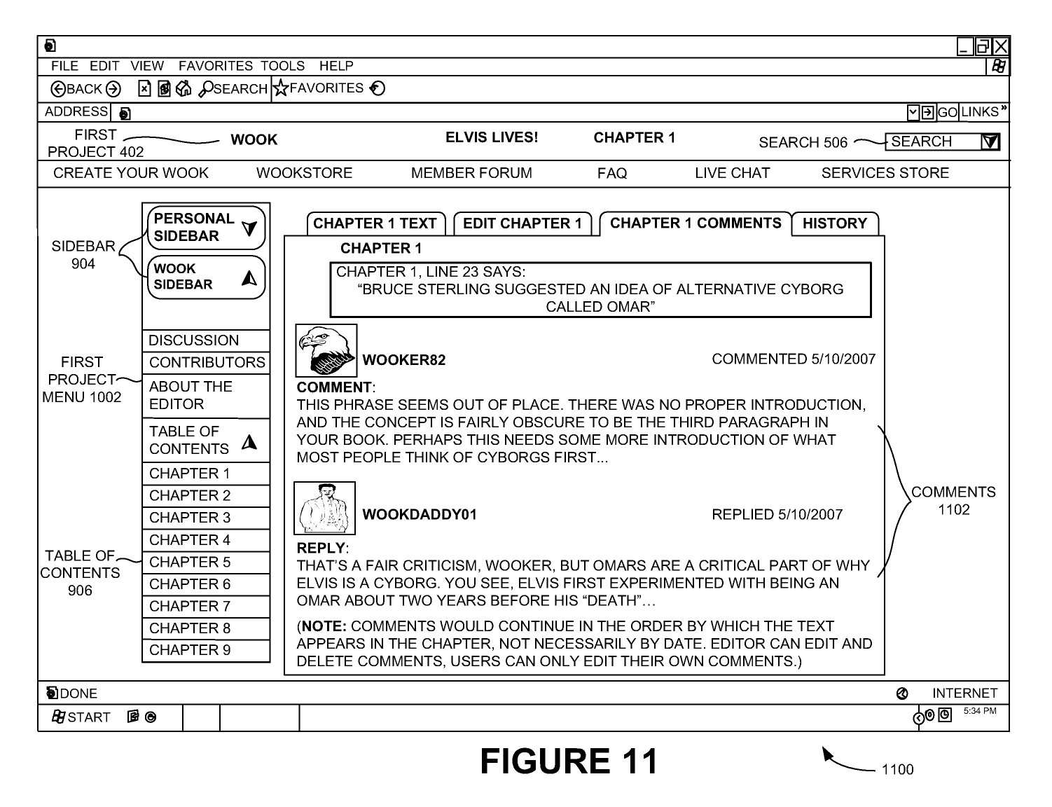

The first project menu 1002 may enable the user 102 to select different chapters associated with the project profile 208. The first project menu 1002 may also enable the user 102 to view discussion, contributors and/or details of the editor associated with the first project 402. The view comment option 1004 may enable the user 102 to view comments (e.g., the comments 1102 of FIG. 11) associated with the first project 402. The user 102 may also post comment 1102 regarding suggestions in the first project 402. Further, the editor of the first project 402 may reply to the comments posted by the user 102.

In the example embodiment illustrated in FIG. 10B, the user interface view 1000B displays the content 404 associated with chapter 1 of Elvis Lives. The user 102 may edit the content 404 associated with chapter 1 based on the privilege level(s) 210 assigned by the editor of Elvis Lives. In one example embodiment, the user 102 may be assigned as a contributor to contribute material for the first project 402. Further, the user 102 may highlight and/or comment a portion of the content 404 associated with Elvis Lives. In one example embodiment illustrated in FIG. 10B, the user 102 has posted a comment (e.g., in chapter 1, line 23), suggesting changes in that sentence.

FIG. 11 is a user interface view 1100 displaying comments 1102 associated with the first project 402, according to one embodiment. Particularly, FIG. 11 illustrates the first project 402, the search option 506, the sidebar 904, the table of contents 906, the first project menu 1002 and the comments 1102, according to one embodiment.

The comments 1102 may be posted by the other users 102 (e.g., contributors, coeditors, readers, etc.) regarding the suggestions associated with the content 404 of the first project 402. The comments 1102 may also facilitate the users 102 to share their thoughts, opinions, suggestions and/or feedback in an interactive format on the project webpage.

In the example embodiment illustrated in FIG. 11, the user interface view 1100 displays the comments 1102 posted by the users 102 (e.g., contributors) of the community network 200 regarding the first project 402. Further, the user 102 (e.g., writer, editor, author, etc.) may reply for the analysis made by the contributors 508 in the comments 1102. Furthermore, these comments 1102 can help the user 102 (e.g., writer, editor, author, etc.) to expand some stuff (e.g., material), correct mistakes, sort content, remove content, etc. associated with the first project 402.

For example, WookDaddy01 may be the user 102 (e.g., writer, editor, author, etc.) of the first project 402 (e.g., Elvis Lives) who receives comments 1102 from a contributor “Wooker82”. The Wooker82 may be interested in the project profile 208 (e.g., Elvis Lives) can post comments 1102 (e.g., regarding his concern about the Elvis Lives) to WookDaddy01 suggesting some modifications in Elvis Lives. Further, WookDaddy01 may respond to the fair analysis given by the Wooker82. In addition, WookDaddy01 may accept or reject the suggestions based on the validity of the comments 1102.

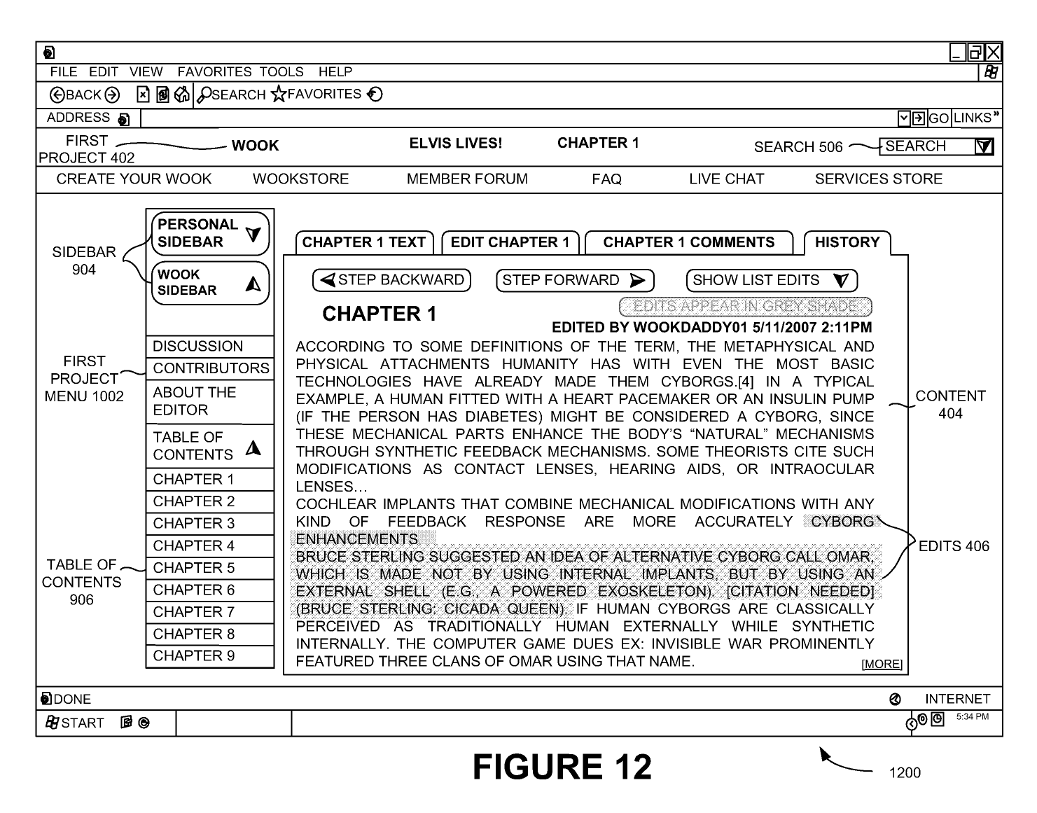

FIG. 12 is a user interface view 1200 displaying history associated with the first project 402, according to one embodiment. Particularly, FIG. 12 illustrates the first project 402, the content 404, the edits 406, the search option 506, the sidebar 904, the first project menu 1002 and the table of contents 906, according to one embodiment.

In the example embodiment illustrated in FIG. 12, the user interface view 1100 displays the content 404 associated with the first project 402 (e.g., Elvis Lives) along with the edits 406 made by WookDaddy01 dated on May 11, 2007 at 2:11 pm. In addition, Elvis Lives may include various chapters of which chapter 1 is displayed based on the requirement associated with Elvis Lives.

The edits 406 may be highlighted in a different color in order to identify the changes made to the previous version and/or for controlling revisions. In one example embodiment, the history of Elvis Lives may include information regarding the contributions (e.g., edits 406, comments 1102 and/or feedbacks) made by all the users 102 (e.g., editors, coeditors, contributors, authors, etc.) to Elvis Lives before publishing Elvis Lives.

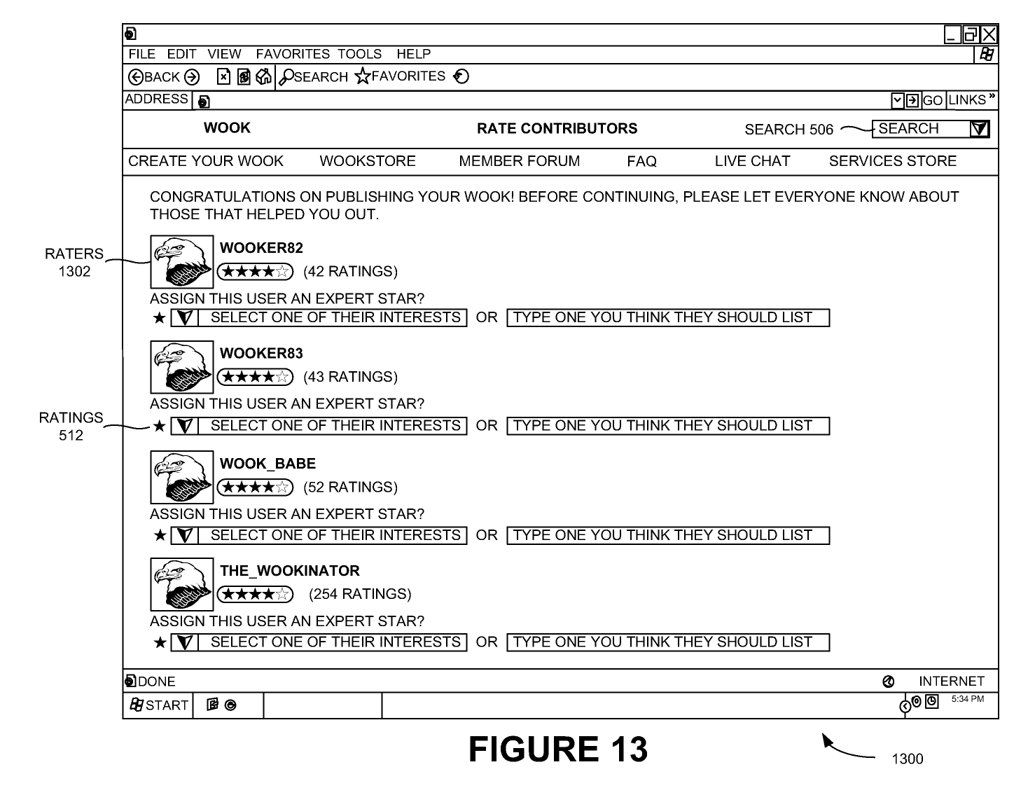

FIG. 13 is a user interface view 1300 of rating contributors 508 associated with the first project 402, according to one embodiment. Particularly, FIG. 13 illustrates the search option 506, the ratings 512 and raters 1302, according to one embodiment. The raters 1302 may be the users 102 (e.g., contributors, editors, coeditors, etc.) who have been rated according to an amount of contribution made by each user 102 to the first project 402.

In the example embodiment illustrated in FIG. 13, the user interface view 1300 displays the contributors Wooker82, Wooker83, Wook_babe, and The_Wookinator, who have been assigned stars (e.g., symbols for classification purpose) based on the amount of contribution made by them to Elvis Lives. The user interface view 1300 also displays information indicating that Elvis Lives has been published by making use of the online collaborations between the user profiles 204. The user 102 (e.g., writer, editor, author, etc.) may differentiate the contributors 508 by using star classification system and incrementing the stars based on the amount of contribution made by each user 102.

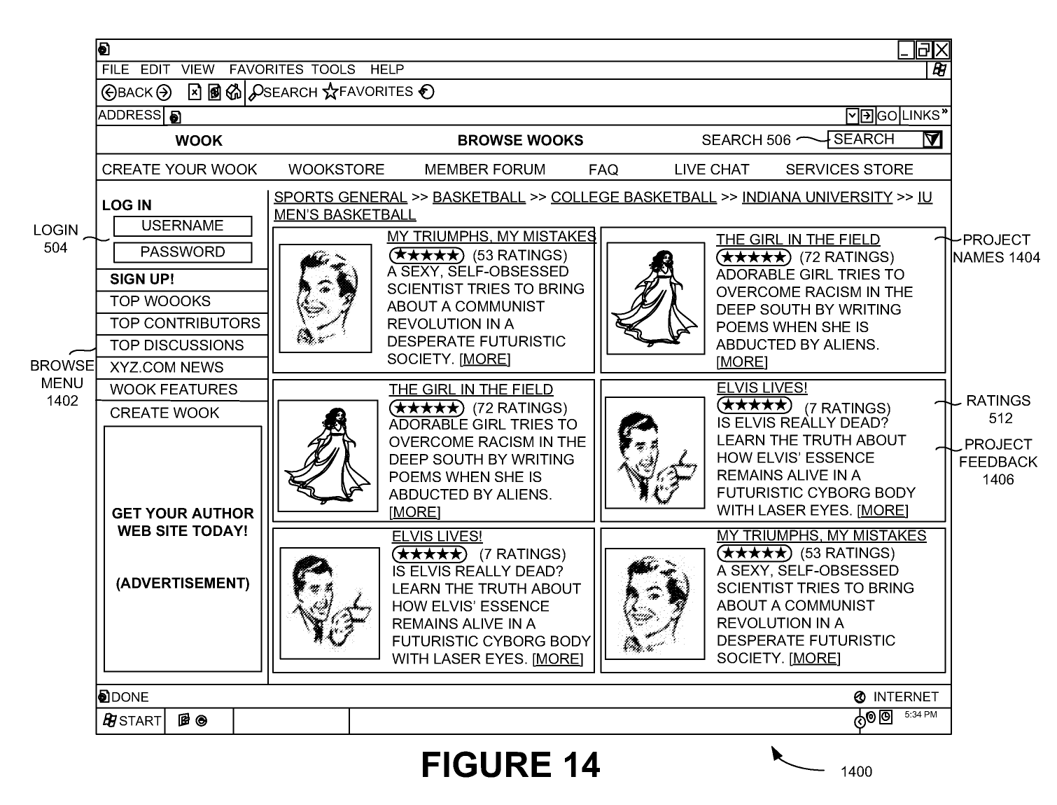

FIG. 14 is a user interface view 1400 of browsing the projects 114, according to one embodiment. Particularly, FIG. 14 illustrates the login option 504, the search option 506, the ratings 512, a browse menu 1402, project names 1404 and a project feedback 1406, according to one embodiment.

The browse menu 1402 may provide different options to browse top wooks, contributors, discussions, news and/or other features of wooks associated with the user profiles 204 in the community network 200. The project names 1404 may represent titles associated with the projects 114 which have been listed by the users 102. The project feedback 1406 may represent a feedback related to a project 114 generated by the users 102 who have been contributed for the project 114.

In the example embodiment illustrated in FIG. 14, the user interface view 1400 may enable the users 102 (e.g., registered users and unregistered users) to browse for the projects 114. The user interface view displays the projects 114 “My triumphs, my mistakes”, “The girl in the field”, “Elvis Lives”, etc. on the webpage along with the ratings 512 and the project feedback 1406. Furthermore, the unregistered users may register into the website to become the members of the community network 200 using the sign up option.

The projects 114 will be displayed on the webpage based on a search conducted by the users 102 interested in contributing the projects 114, but the content 404 may not be viewed and/or edited by the users 102 until the privilege level(s) 210 associated with the projects 114 are assigned to the users 102.

In one embodiment, a search associated with the user profiles 204 and/or the project profiles 208 may be generated (e.g., using the search module 336 of FIG. 3C). Tags associated with interest categories may be searched (e.g., using the search tags module 336A of FIG. 3C). A portion of the user profiles 204 and a portion of the project profiles 208 may be searched in full text mode (e.g., using the search full text module 336B of FIG. 3C). The project profiles 208 may be searched based on a topic and/or a genre (e.g., using the search topics module 336C of FIG. 3C).

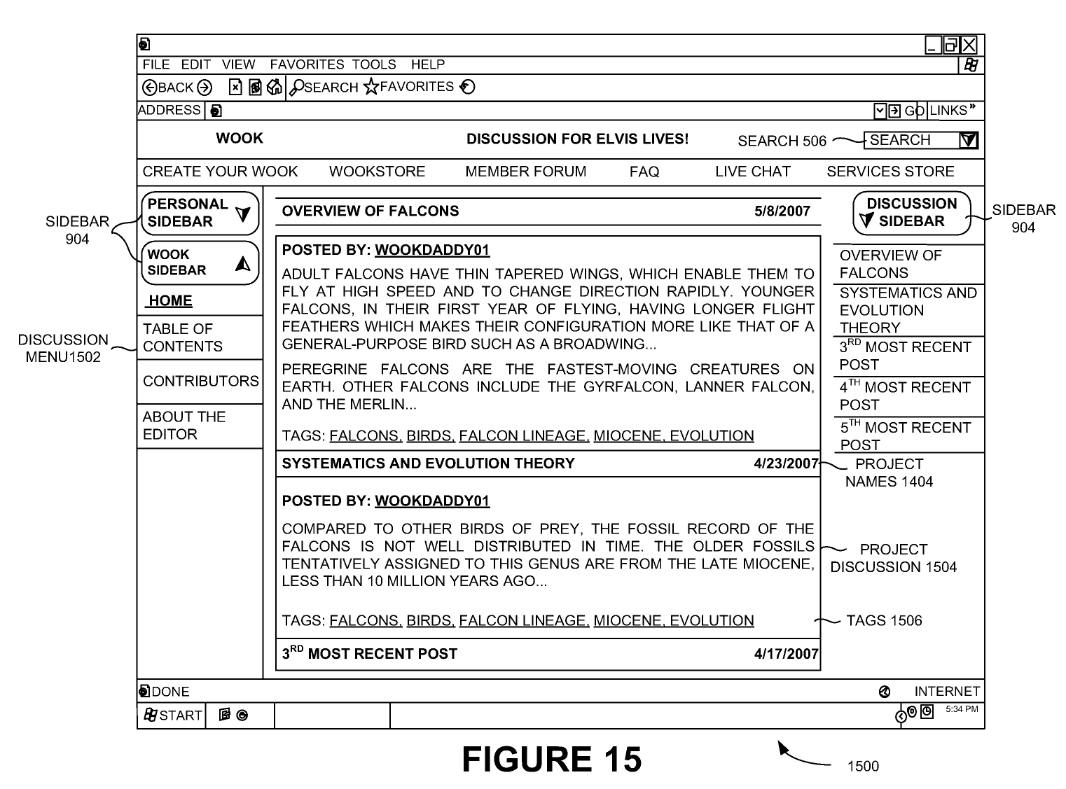

FIG. 15 is a user interface view 1500 displaying a discussion associated with the first project 402, according to one embodiment. Particularly, FIG. 15 illustrates the search option 506, the sidebar 904, a discussion menu 1502, a project discussion 1504 and tags 1506, according to one embodiment.

The discussion menu 1502 may provide different options to view discussions associated with the user profile 204 related to the first project 402. For example, the discussion may be a website where users 102 associated with user profiles 204 may post informal journals of their thoughts, comments, and/or philosophies, updated frequently and normally reflecting the views of the discussion's creator. The project discussion 1504 may display information posted by the writer regarding the first project 402. The tags 1506 may be used to store information about the project profile 208 and are used in indexing. In one example embodiment, the first project may be associated with different tags.

In the example embodiment illustrated in FIG. 15, the user interface view 1500 displays a discussion showing information posted by the editor “WookDaddy01” regarding Elvis Lives. The discussion may correspond to a wook kept on the online network (e.g., Internet). The wook may be often updated daily and contains information that the writer maintaining the discussion wishes to share with the other users 102 of the community environment 100.

The discussion may also refer to a website dedicated to a particular topic and capable of being updated with the latest news, views and trends. WookDaddy01 may be maintaining the discussion and continuously updating information regarding the wook “Elvis Lives”. For example, the user interface view 1500 displays project names “Overview of Falcons”, “Systematics and Evolution Theory” and “3^{rd} most recent post” associated with Elvis Lives and updated on dates “May 8, 2007”, “Apr. 23, 2007” and “Apr. 17, 2007” respectively. The user interface view 1500 also displays tags associated with each project discussion 1504.

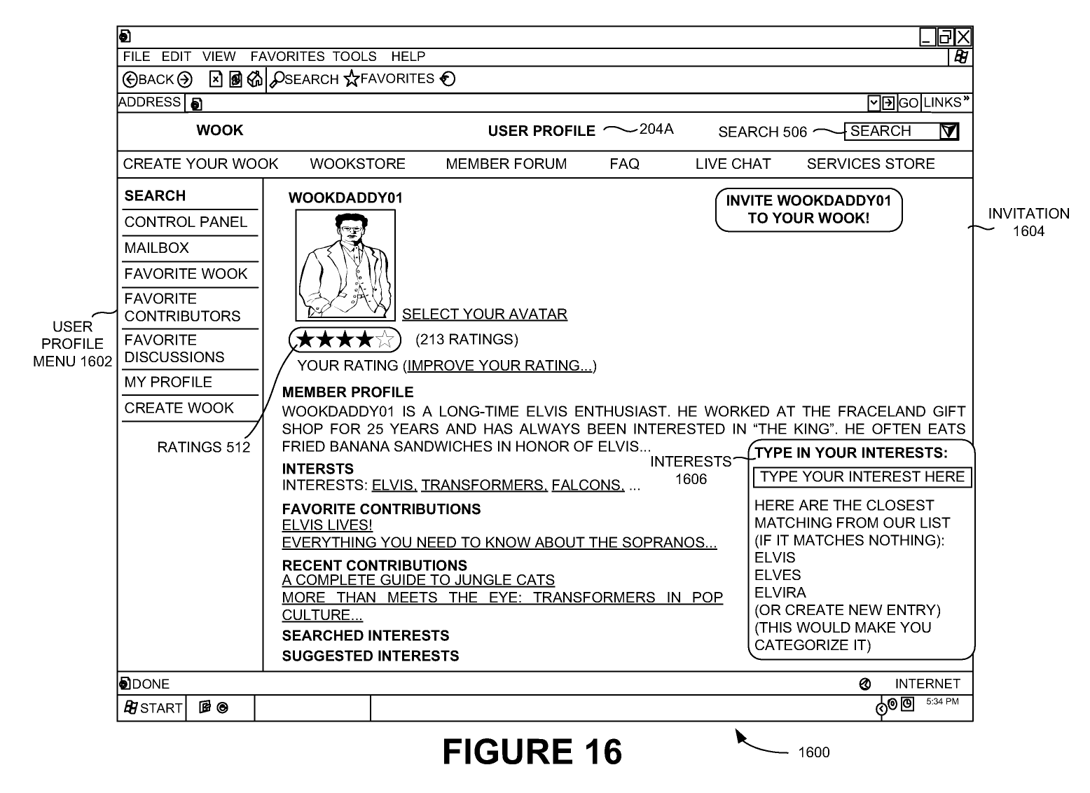

FIG. 16 is a user interface view 1600 displaying a user profile (e.g., of the user profiles 204 of FIG. 2), according to one embodiment. Particularly, FIG. 16 illustrates the search option 506, the ratings 512, a user profile menu 1602, an invitation option 1604 and interests block 1606, according to one embodiment.

The user profile menu 1602 may enable the users 102 of the community network 200 to view profile information associated with the user profile 204. For example, the profile information may include favorite wooks, favorite contributions, and/or other personal information associated with the user profile 204.

The invitation option 1604 may allow the other users 102 to invite the user associated with the user profile 204 to participate in their projects (e.g., the projects 114 of FIG. 1) associated with the project profiles 204. In one example embodiment, the users 102 of the community network 200 may invite the user associated with user profile 204 based on the interests specified in the user profile 204.

The interests block 1606 may enable the users 102 of the community network 200 to search for wooks by providing interests as a search query. Further, the interests block 1606 may display closest wooks corresponding to the interest of the users 102 based on the requested search query.

In the example embodiment illustrated in FIG. 16, the user interface view 1600 displays the user profile 204 associated with a user “WookDaddy01”. The users 102 of the community network 200 may view the profile information (e.g., wooks, contributions, discussions, profile, etc.) associated with WookDaddy01 using the user profile menu 1602. Further, the users 102 may invite WookDaddy01 to contribute for their projects based on the interests of WookDaddy01 specified in the user profile 204.

For example, if a user 102 may be looking for a contributor interested in falcons, the user 102 may invite WookDaddy01 to contribute for the wook on falcons as WookDaddy01 mentioned one of the interests as “Falcons” in the user profile 204. The user profile 204 also includes the favorite contributions and/or recent contributions made by WookDaddy01 which are displayed to other users 102 on the webpage. The users 102 may also search for the other users 102 by providing different search query as illustrated in the interests block 1606.

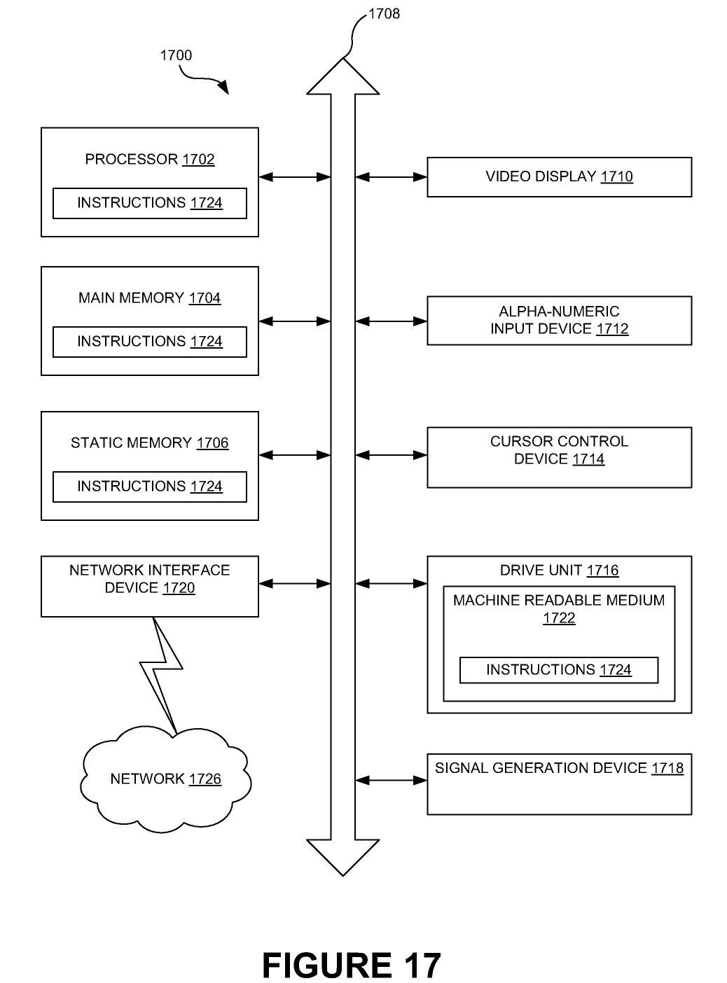

FIG. 17 is a diagrammatic system view 1700 of a data processing system in which any of the embodiments disclosed herein may be performed, according to one embodiment. Particularly, the diagrammatic system view 1700 of FIG. 17 illustrates a processor 1702, a main memory 1704, a static memory 1706, a bus 1708, a video display 1710, an alpha-numeric input device 1712, a cursor control device 1714, a drive unit 1716, a signal generation device 1718, a network interface device 1720, a machine readable medium 1722, instructions 1724 and a network 1726, according to one embodiment.

The diagrammatic system view 1700 may indicate a personal computer and/or a data processing system in which one or more operations disclosed herein are performed. The processor 1702 may be microprocessor, a state machine, an application specific integrated circuit, a field programmable gate array, etc. (e.g., Intel® Pentium® processor). The main memory 1704 may be a dynamic random access memory and/or a primary memory of a computer system.

The static memory 1706 may be a hard drive, a flash drive, and/or other memory information associated with the data processing system. The bus 1708 may be an interconnection between various circuits and/or structures of the data processing system. The video display 1710 may provide graphical representation of information on the data processing system. The alpha-numeric input device 1712 may be a keypad, keyboard and/or any other input device of text (e.g., special device to aid the physically handicapped). The cursor control device 1714 may be a pointing device such as a mouse.

The drive unit 1716 may be the hard drive, a storage system, and/or other longer term storage subsystem. The signal generation device 1718 may be a bios and/or a functional operating system of the data processing system. The network interface device 1720 may be a device that may perform interface functions such as code conversion, protocol conversion and/or buffering required for communication to and from a network. The machine readable medium 1722 may provide instructions on which any of the methods disclosed herein may be performed. The instructions 1724 may provide source code and/or data code to the processor 1702 to enable any one or more operations disclosed herein.

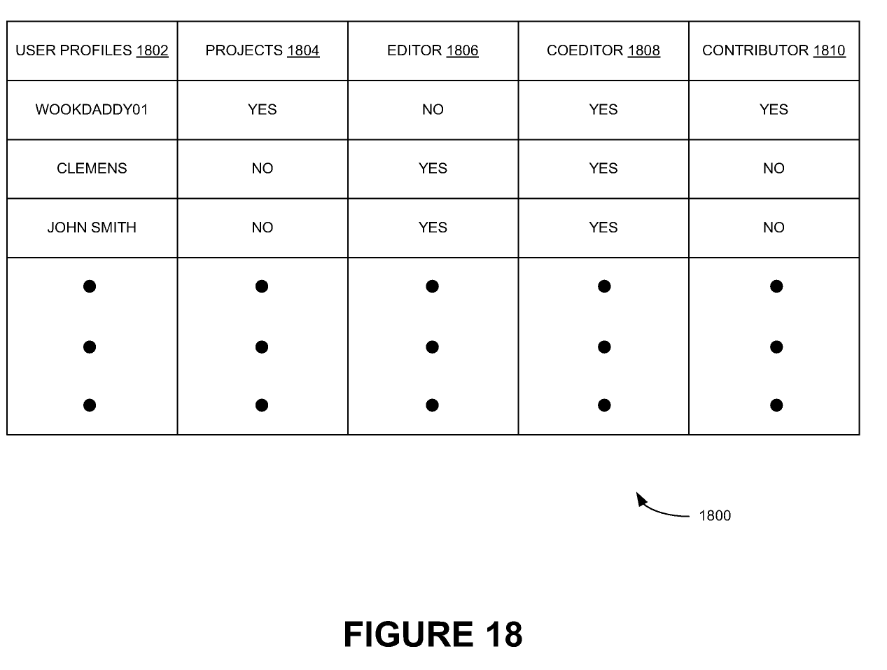

FIG. 18 is a table view 1800 displaying the privilege level(s) 210 associated with the user profiles 204 related to a project 114, according to one embodiment. Particularly, FIG. 18 illustrates a user profiles field 1802, a projects field 1804, an editor field 1806, a coeditor field 1808 and a contributor field 1810, according to one embodiment.

The user profiles field 1802 may display a unique identifier (e.g., name, code, unique key, etc.) referencing users 102 associated with the user profiles 204 in the community network 200. The projects field 1804 may indicate whether a project 114 is associated with the user profile 204 or not. The editor field 1806 may designate the editors among the user profiles 204 in the user profiles field column 1802. The coeditor field 1808 may indicate the coeditors among the user profiles 204 in the user profiles field column 1802.

The contributor field 1810 may indicate the contributors among the user profiles 204 who have been contributed material to the project 114. In one example embodiment, a user 102 may be designated the privilege level(s) 210 based on the previous contributions, ratings and/or interests associated with the user 102.

In the example embodiment illustrated in FIG. 18, the user profiles field 1802 displays “WookDaddy01” in the first row, “Clemens” in the second row and “John Smith” in the third row of the user profiles field column 1802. The projects field 1804 displays “Yes” in the first row, “No” in the second row and “No” in the third row of the projects field column 1804 indicating WookDaddy01 is the owner (e.g., author) of the project 114. The editor field 1806 displays “No” in the first row, “Yes” in the second row, and “Yes” in the third row of the editor field column 1806 indicating that Clemens and John Smith are assigned the privilege level(s) as the editor of the project 114.

The coeditor field 1808 displays “Yes” in the first row, “Yes” in the second row and “Yes” in the third row of the coeditor field column 1808 indicating that WookDaddy01, Clemens and John Smith are the coeditors of the project 114. The contributor field 1810 displays “Yes” in the first row, “No” in the second row and “No” in the third row of the contributor field column 1810 indicating that WookDaddy01 is also the contributor of the project 114.

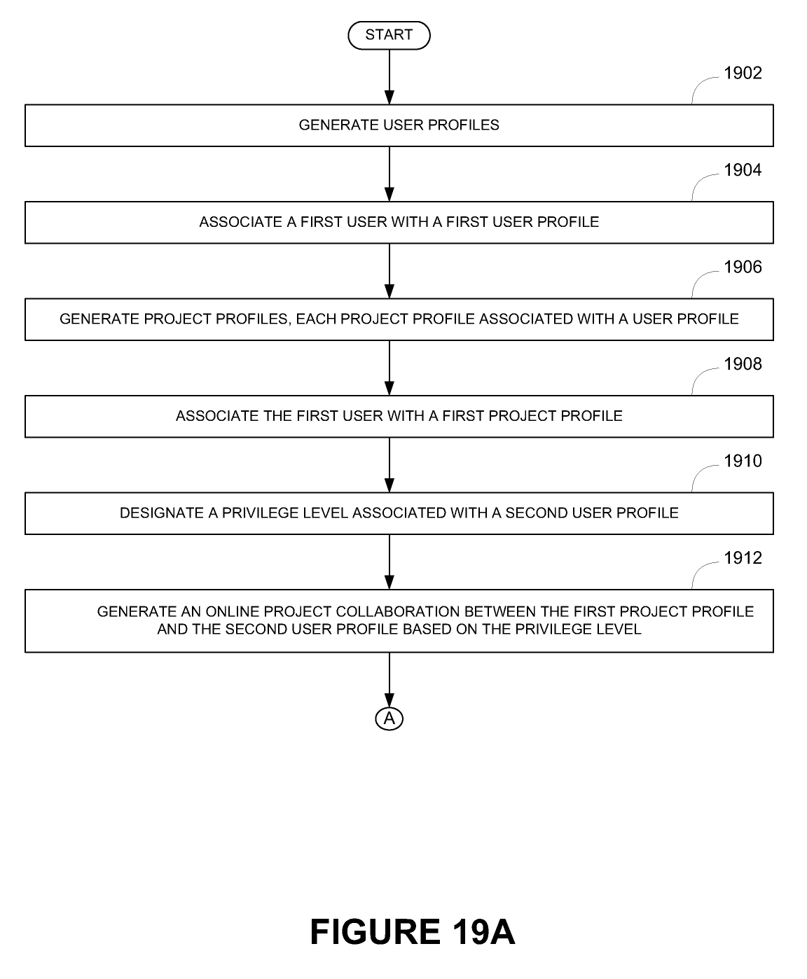

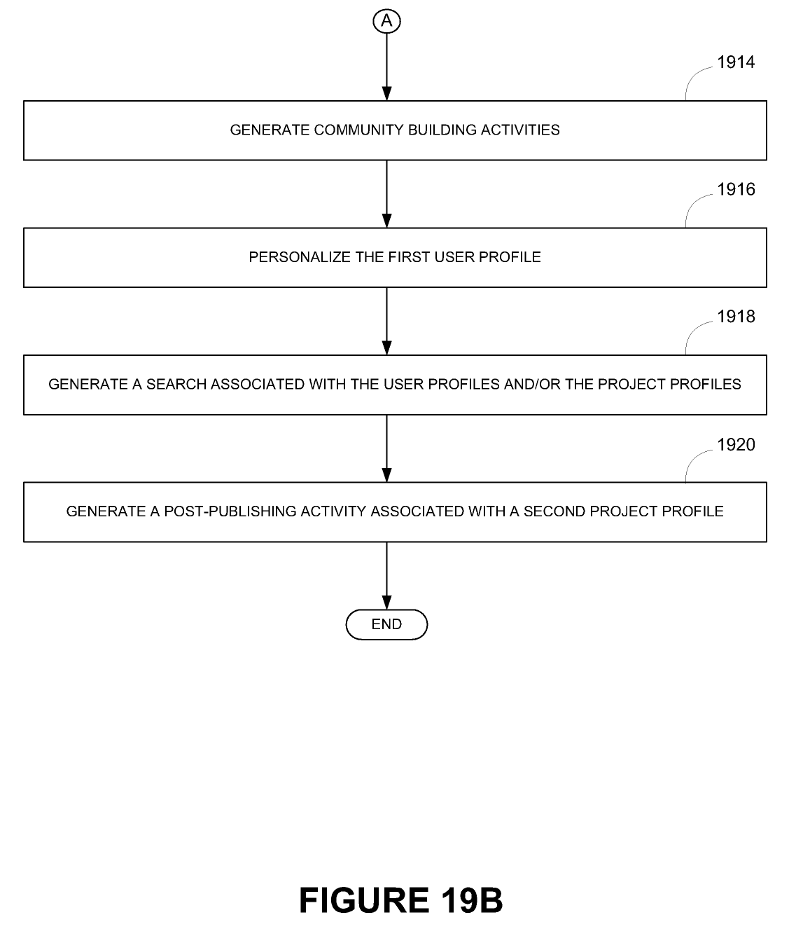

FIG. 19A is a process flow of generating an online project collaboration between project profiles (e.g., the project profiles 208 of FIG. 2) and user profiles (e.g., the user profiles 204 of FIG. 2), according to one embodiment. In operation 1902, the user profiles 204 may be generated. In operation 1904, a first user (e.g., of the users 102 of FIG. 1) may be associated with a first user profile (e.g., the first user profile 204A of FIG. 4). In operation 1906, the project profiles 208 may be generated, each project profile 208 associated with a user profile (e.g., of the user profiles 204 of FIG. 2).

In operation 1908, the first user 102 may be associated with a first project profile (e.g., the first project profile 208A of FIG. 4). In operation 1910, a privilege level (e.g., the privilege level(s) 210 of FIG. 2-4) associated with a second user profile (e.g., of the other user profiles 204B of FIG. 4) may be designated (e.g., using the privilege level module 108 of FIG. 1). In operation 1912, the online project collaboration may be generated (e.g., using the online project collaboration module 110 of FIG. 1) between the first project profile 208A and the second user profile 204B based on the privilege level(s) 210.

FIG. 19B is a continuation of the process flow of FIG. 19A, illustrating additional processes, according to one embodiment. In operation 1914, community building activities may be generated (e.g., using the community building module 332 of FIG. 3B). In operation 1916, the first user profile 204A may be personalized (e.g., using the user profile module 334 of FIG. 3B). In operation 1918, a search associated with the user profiles 204 and/or the project profiles 208 may be generated (e.g., using the search module 336 of FIG. 3C).

In operation 1920, a post-publishing activity associated with a second project profile may be generated (e.g., using the post-publishing module 338 of FIG. 3C). For example, the second project profile may be a project 114 collaborated by the users 102 of the online network (e.g., Internet) and/or a project 114 uploaded by an author without need for collaboration contributions that just needs to be published.

FIG. 20 is an exploded view of the external collaboration module 112 of FIG. 1 having a content placement module 2014 and other modules, according to one embodiment. Particularly FIG. 20 illustrates a work of authorship 2000, a widget generator module 2002, a real simple syndication module 2004, a content versioning module 2006, a response analyzer module 2008, a content integration module 2010, a collaborated content 2012, and a content placement module 2014, according to one embodiment.

The work of authorship 2000 (e.g., literary work, etc.) may be a considerable and fixed creative work of a character originated by its author (e.g., a book, an article, sheet music, movies, records, tape recordings, video disk productions, computer software, laser disk games, cartoons, designs, magazines, poems, etc.). The widget generator module 2002 may embed chunks of code for Real Simple Syndication (RSS) feed (e.g., may be called as feed, web feed, channel, etc.) in various social networks (e.g., Orkut®, Facebook®, etc.).

The real simple syndication module 2004 may contain either a summary of content from work of authorship (e.g., literary work, etc.) in a community environment 100. The real simple syndication module 2004 may make it possible for the users 102 to keep up with the latest updates associated with the author and his works (e.g., books, poetry, etc.) in an automated manner that is easier than checking them manually. The content versioning module 2006 may keep dates and/or serialized copies of all the different versions of contents (e.g., author works, etc.).

The response analyzer module 2008 may enable the community environment 100 to analyze the response from the users 102 towards the work (e.g., the literary work, etc.). The content integration module 2010 may allow integration of content associated with authors, works of the author (e.g., literary work, etc.), response of the user 102 and the latest updates associated to the authors in a profile page. The collaborated content 2012 may include work of the author (e.g., stories, picture, etc.), response from the user 102, etc.

The content placement module 2014 may place content and the contribution of the work of authorship 2000 based on a pre-defined template layout chosen by the author 102 and the other authors 102 as a model from which to place the content and the contribution associated with the work of authorship 2000.

In the example embodiment illustrated in FIG. 20, the collaborated content 2012 may be inside the work of authorship 2000. The work of authorship 2000 may be leveraged by the content integration module 2010 and the content placement module 2014 as illustrated in FIG. 20. The Real simple syndication 2004 may communicate with the work of authorship 2000 block. The response analyzer module 2008 may communicate with content integration module 2010 and content versioning module 2006. The response analyzer module may also communicate with the external social communities 116.

In one embodiment, the work of authorship 2000 may be built through a collective coordination of authors of the work of authorship 2000 in the community environment 100. A portion of content of the work of authorship 2000 on an external social community 116 may be provided through a feed (e.g., may be displayed on a profile page in the external social community 116 of the authors of the work of authorship 2000 collectively coordinating to the building of the work of authorship 2000 in the community environment 100) from the community environment 100 to the external social community 116.

A response of a user 102 of the external social community 116 may be processed in contributing to the work of authorship 100. The response of the user 102 of the external social community 116 may be integrated in the work of authorship 2000. The response of the user 102 of the external social community 116 may include additional content and/or discussion summary that may be incorporated into the portion of the work of authorship 2000.

The feed may be provided as a Real Simple Syndication (RSS) feed, as an embeddable widget, and/or an activity announcement based on an update of the work of authorship 2000 in the community environment 100. The activity announcement may be presented in the external social community 116 as a question to users 102 of the external social community 116. The user 102 of the external social community 116 may be transformed into authors of the work of authorship 2000 in the community environment 100 when the user 102 of the external social community 100 contributes content to the work of authorship 2000 through the response.

A presentation of content of the work of authorship 2000 may be customized through a template having a set of guidelines that define a category associated with the work of authorship 2000. An update of the portion of the work of authorship 2000 embodying the response of the user 102 may be automatically published in other external social community 116 upon integrating the response of the user 102. The work of authorship 2000 may be published in a print form and/or an online form. The work of authorship 2000 may be distributed through a series of distribution channels including retail distribution partner and/or a wholesale distribution partner.

The work of authorship 2000 may be created through a collective contribution of content by members of a community environment 100 and/or users 102 of an external social community 116. The work of authorship 2000 may be printed based on a set of orders received through distribution partner associated with the work of authorship 2000. A portion of the work of authorship 2000 may be published in the external social community 116 such that users 102 of the external social community 116 can interact with the published content through commentary and/or contribution associated with the published content in the external social community 116.

The set of external social communities 116 associated with the author that may publish a snippet of the authorship in the external social communities such that the snippet enables contribution to the work of authorship 2000 by users 102 of the external social community 116. The contribution may includes a picture content associated with the snippet, a quote associated with the snippet, a video content associated with the snippet, and/or a text clip associated with the snippet. The snippet may be made visible on a profile page of the author and authors in the external social community 116.

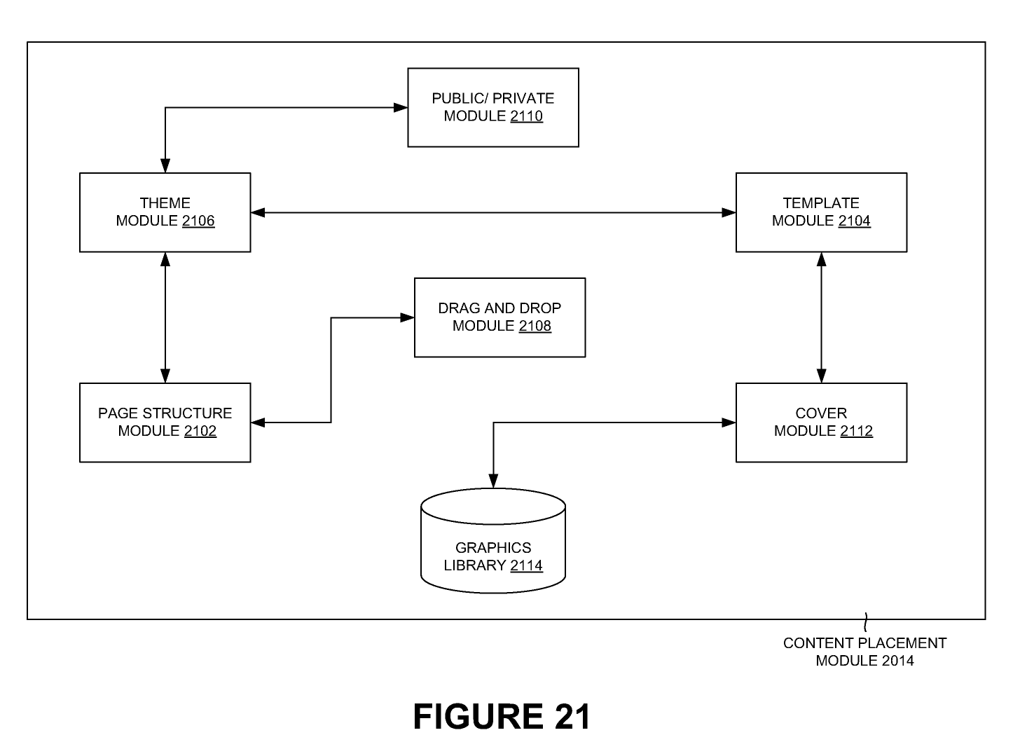

FIG. 21 is an exploded view of the content placement module 2014 of FIG. 20, according to one embodiment. Particularly, FIG. 21 illustrates a page structure module 2102, a template module 2104, a theme module 2106, a drag and drop module 2108, a public/private module 2110, a cover module 2112, and a graphics library 2114, according to one embodiment.

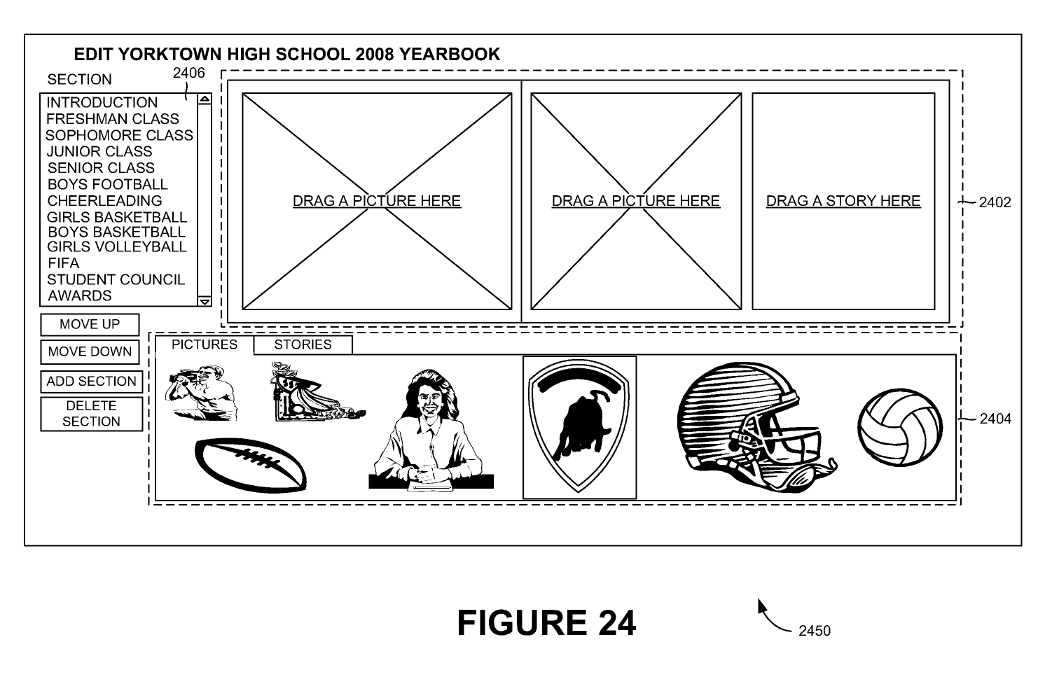

The page structure module 2102 may enable a page structure tool in the community environment 100, and may enable the community environment 100 to accept a URL (e.g., to embed links in a site, etc.) and templates for structuring the profile page of the author. The template module 2104 may enable the author to create a profile page using templates already present. The theme module 2106 may allow the author to select a theme (e.g., using theme picker 2204) of his likeliness in the set of themes (e.g., using theme library 2206) present for his book. The drag and drop module 2108 may allow the action of clicking on a virtual object and dragging it to a different location or onto another virtual object so that the author may place the contents of his profile page in order of his choice (e.g., as illustrated in FIG. 24). The public/private module 2110 may enable the author to decide whether his profile page to be private/public as per his requirements. The cover module 2112 may enable the author to design a cover for his book through the cover templates and designs from the graphics library 2114. The graphics library 2114 may enable the author to add graphics to book cover page as per his choice and likeliness.

In the example embodiment illustrated in FIG. 21, the theme module 2106 may communicate with public/private module 2110, template module 2104 and page structure module 2102. The template module 2104 may communicate with cover module 2112. The drag and drop module 2108 may communicate with page structure module 2102. The cover module may take graphics from graphics library 2114.

In one embodiment, content may be placed in a region of a page based on the template (e.g., may be a poetry book template, a year book template, a novel template, a non-fiction book template, a picture book template, a family book template, and/or a multimedia book template, etc.) as directed by a request of the authors. Creative control may be assigned over the placement to an editor author of authors.

Content may be placed in predetermined sections of the template embodying a preferred style based on a category of the work of authorship 2000. A content placement module 2014 of the community environment 100 may place content and the contribution of the work of authorship 2000 based on a pre-defined template layout chosen by the author and the other authors as a model from which to place the content and the contribution associated with the work of authorship 2000.

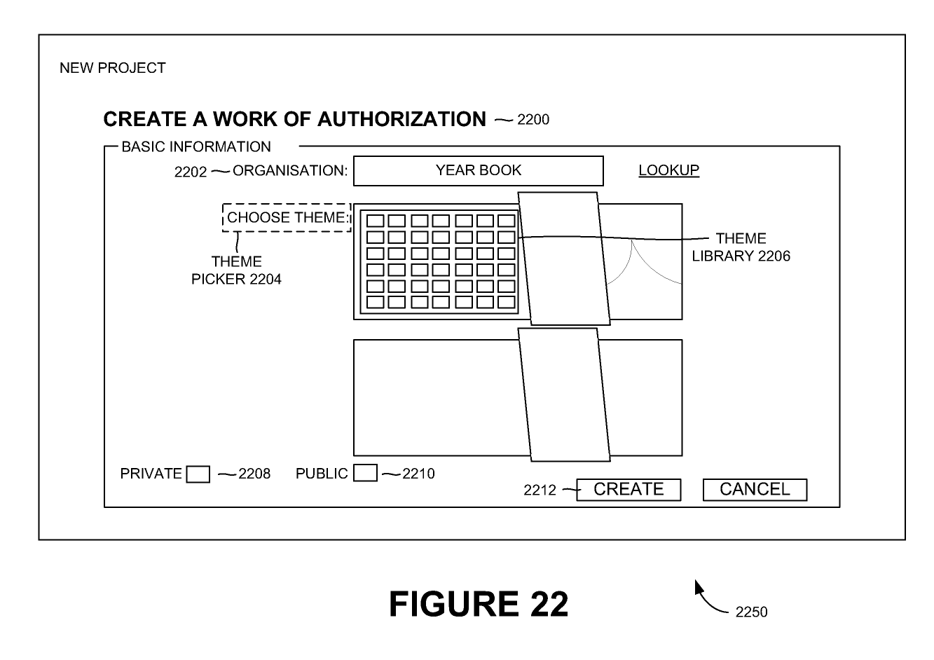

FIG. 22 is a user interface view 2250 of applying a theme (e.g., from a theme library 2206 of FIG. 22) to a category of works of authorship 2000 through the content placement module 2014, according to one embodiment. Particularly FIG. 22 illustrates create a work of authorship 2200, organization 2202, a theme picker 2204, a theme library 2206, a private option 2208, a public option 2210, and a create option 2212, according to one embodiment.

The create a work of authorship 2200 option may be used to create an exclusive work of authorship 2000 associated to the author by providing some basic information associated to it. The organization 2202 option enables the author to state his organization (e.g., year book as illustrated) for the purpose or creating a work of a work of authorship 2200. The theme picker 2204 option may allow the author to choose a theme for his work (e.g., literary work, etc.) from the theme library 2206. The theme library 2206 may allow the author to choose a variety of themes for his work. The private option 2208 may enable the author to keep his work as a private matter. The public option 2210 may enable the author to make his work (e.g., literary work, etc) open for public for communication. The create option 2212 may enable the author to create the work of authorship 2200 after filling up all the required information associated to it.

In the example embodiment illustrated in FIG. 22, the author is creating his exclusive authorship for his work (e.g., literary works) using various themes from theme library and using the options like public/private to customize his work (e.g., literary work, etc.)

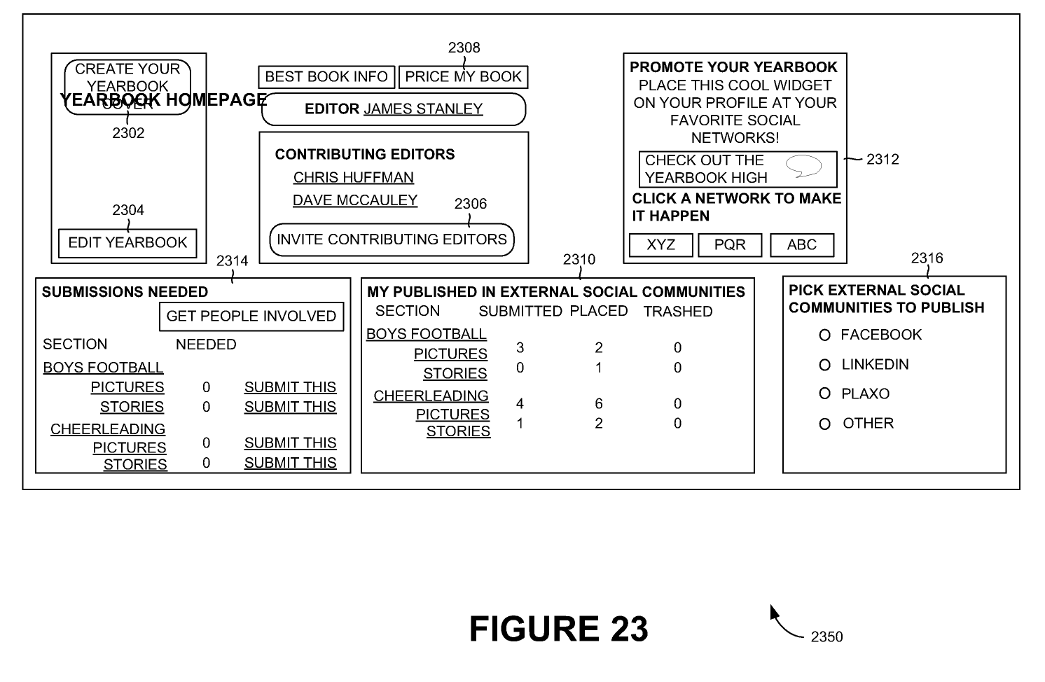

FIG. 23 is a user interface view 2350 of customizing communication with external social communities 116, according to one embodiment. Particularly FIG. 23, illustrates an option 2302, an option 2304, an option 2306, an option 2308, an option 2310, an option 2312, and an option 2314 according to one embodiment.

The option 2302 may enable the author to create his work cover page (e.g., cover page of his book, etc.). The option 2304 may enable the author to edit the work (e.g., edit his literary work, etc.). The option 2306 may enable the author to invite contributing editors for his work (e.g., for selling his product, etc.). The option 2308 may enable the author to price his book as per his interest. The option 2310 may display works of the author which are published in the communities. The option 2312 may enable the author to promote his book by placing a widget into various social networks where the author profile exists. The option 2314 may enable the author to submit (e.g., upload, etc.) the work to his profile.

In the example embodiment illustrated in FIG. 23, the user interface view 2350 displays various tools to enhance his work (e.g., literary work, etc.) like creating cover page option 2302, pricing the book 2308, inviting contributing editors 2306, promotion of his work by placing widgets in different social networks, etc. The user interface view 2350 may also display the published works in external social communities and also provides an option to publish the book into different social communities.

FIG. 24 is a user interface view 2450 of content placement by applying the content placement module 2014, according to one embodiment. Particularly, FIG. 24 illustrates an option 2402, an option 2404, and an options 2406 according to one embodiment.

The option 2402 may enable the user with a space to drag and drop, related pictures, story, etc. The option 2404 may enable the author to pick the pictures, stories etc. created by himself to drop them into the space provided in the user interface view 2450. The options 2406 may have various listings like literary work, awards, etc. of the author.

In the example embodiment illustrated in FIG. 24, the user interface view 2450 may display spaces to fill in contents (e.g., stories, pictures, etc.). The user interface view 2450 may also display all the works, awards, etc. of the author.

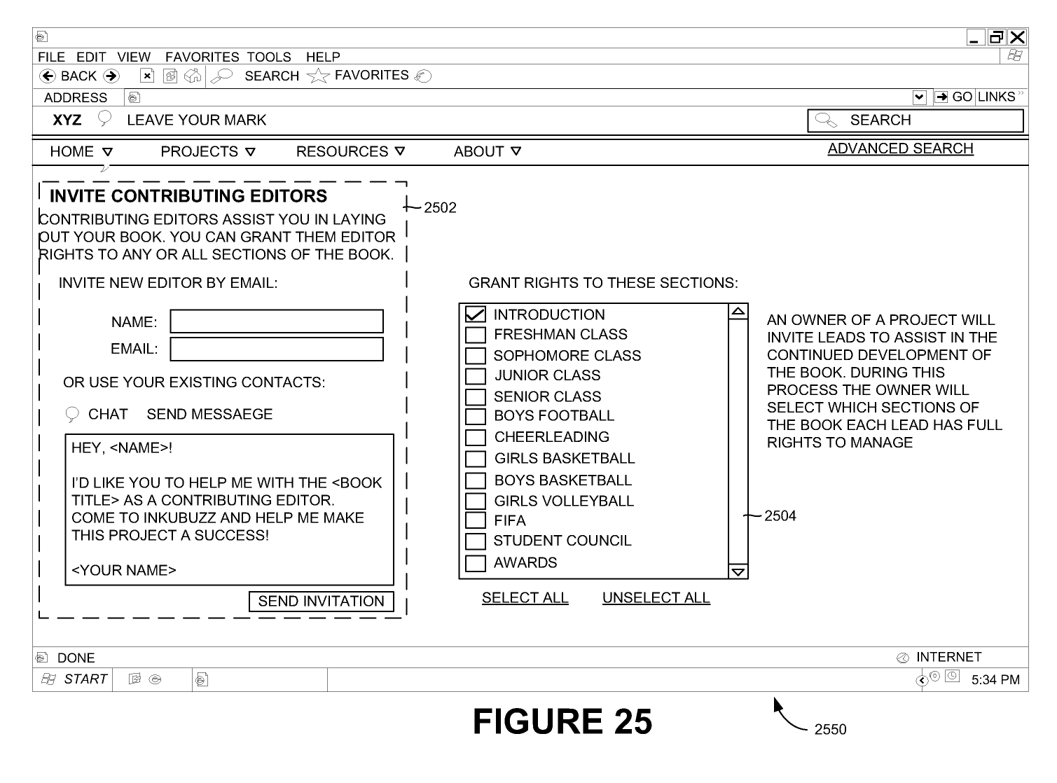

FIG. 25 is a contributor invitation view, according to one embodiment. Particularly, FIG. 25 illustrates an option 2502, and an option 2504 according to one embodiment.

The option 2502 may enable the author to invite contributing editors (e.g., using the name, email, message box, etc.) for development of the work (e.g., literary work, etc.) of the author. The option 2504 may enable the author to grant right on particular sections to particular contributing editor for the development of the work (e.g., literary work, etc.).

In the example embodiment illustrated in FIG. 25, the author may invite contributing editors for development of his work (e.g., literary work, etc.).

In one embodiment, the editor author may decide roles of other authors in relation to the work of authorship 2000. The roles may include a section editor role, a writer role, a contributor role, and/or a publisher role. The users 102 of the external social community 116 may be designated as contributors to the work of authorship 2000 in the community environment 116 without designating them as authors of the work of authorship 2000.

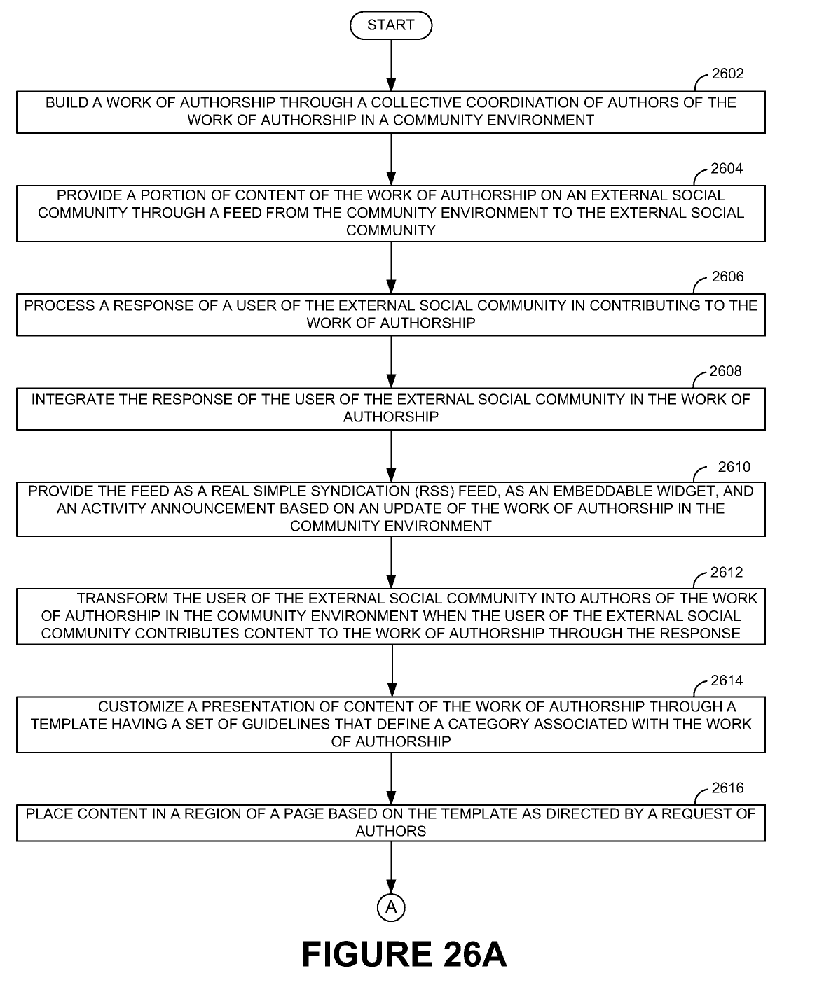

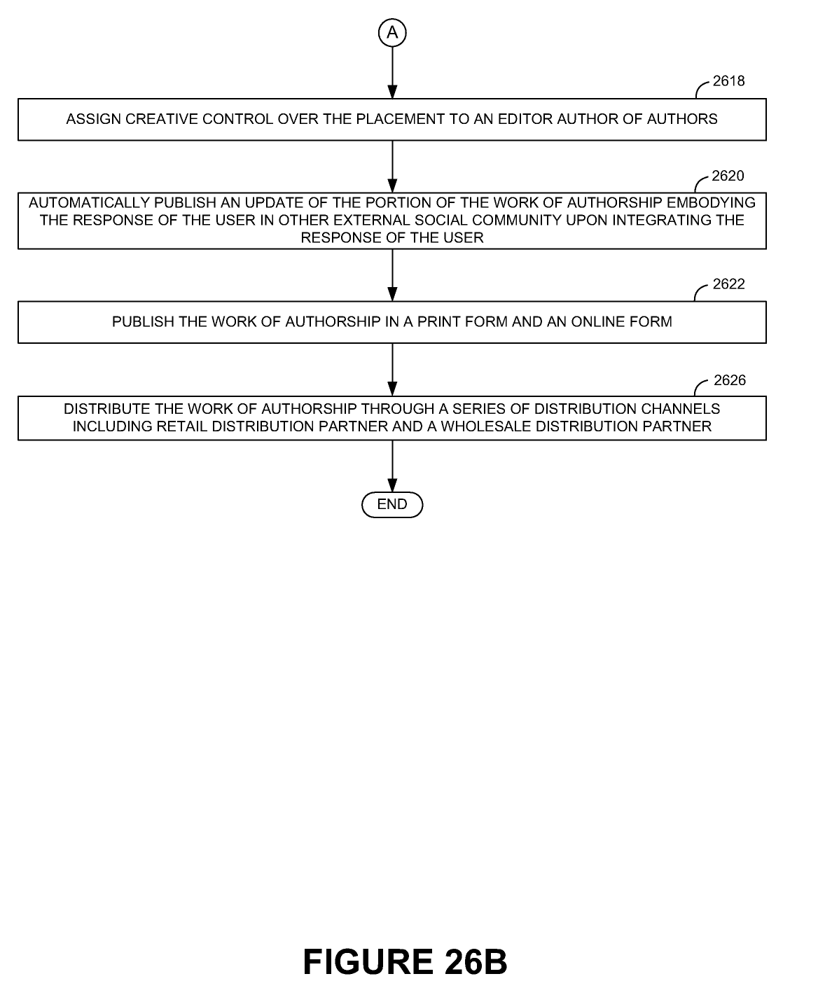

FIG. 26 is a process flow of building a work of authorship (e.g., the work of authorship 2000 of FIG. 20), according to one embodiment. In operation 2602, a work of authorship 2000 may be built through a collective coordination of authors of the work of authorship 2000 in a community environment (e.g., the community environment 100 of FIG. 1). In operation 2604, a portion of content of the work of authorship 2000 (e.g., stories, poems, etc.) may be provided on an external social community (e.g., the external social community 116 of FIG. 1) through a feed (e.g., a Real Simple Syndication (RSS) feed, as an embeddable widget, and/or an activity, etc.) from the community environment 100 to the external social community 116 (e.g., Facebook®, MySpace®, Plaxo®, etc.). In operation 2606, a response of a user 102 of the external social community 100 (e.g., may be comment, suggestions, etc.) may be processed (e.g., using the response analyzer module 2008 of FIG. 20) in contributing to the work of authorship 2000. In operation 2608, the response of the user 102 of the external social community 116 may be integrated (e.g., using the content integration module 2010 of FIG. 20) in the work of authorship 2000.

In operation 2610, the feed as of a Real Simple Syndication (RSS) feed, as an embeddable widget, and/or an activity announcement (e.g., may be presented in the external social community as a question to users of the external social community) may be provided based on an update of the work of authorship 2000 in the community environment 100. In operation 2612, the user 102 of the external social community 116 presented in the external social community 116 may be transformed into authors of the work of authorship 2000 in the community environment 100 when the user 102 of the external social community 116 contributes content to the work of authorship 2000 through the response.

In operation 2614, a presentation of content of the work of authorship 2000 may be customized through a template (e.g., may be a poetry book template, a year book template, a novel template, a non-fiction book template, a picture book template, a family book template, and/or a multimedia book template) having a set of guidelines that define a category associated with the work of authorship 2000 (e.g., using the template module 2104 of FIG. 21). In operation 2616, content may be placed (e.g., using content placement module 2014 of FIG. 20) in a region of a page based on the template as directed by a request of the authors (e.g., as illustrated in FIG. 24).

FIG. 26B is a continuation of the process flow of FIG. 26A illustrating additional processes, according to one embodiment. In operation 2618, creative control may be assigned over the placement to an editor author of the authors (e.g., as illustrated in FIG. 25). In operation 2620, an update of the portion of the work of authorship 2000 embodying the response of the user 102 may be automatically published in other external social community (e.g., using the feeds) upon integrating the response of the user 102. In operation 2622, the work of authorship 2000 may be published in a print form and/or an online form (e.g., using the publishing module 118 of FIG. 118 of FIG. 1). In operation 2624, the work of authorship 2000 may be distributed through a series of distribution channels including retail distribution partner (e.g., retail distribution partner 122 of FIG. 1) and/or a wholesale distribution partner (e.g., the wholesale distribution partner 124 of FIG. 1).

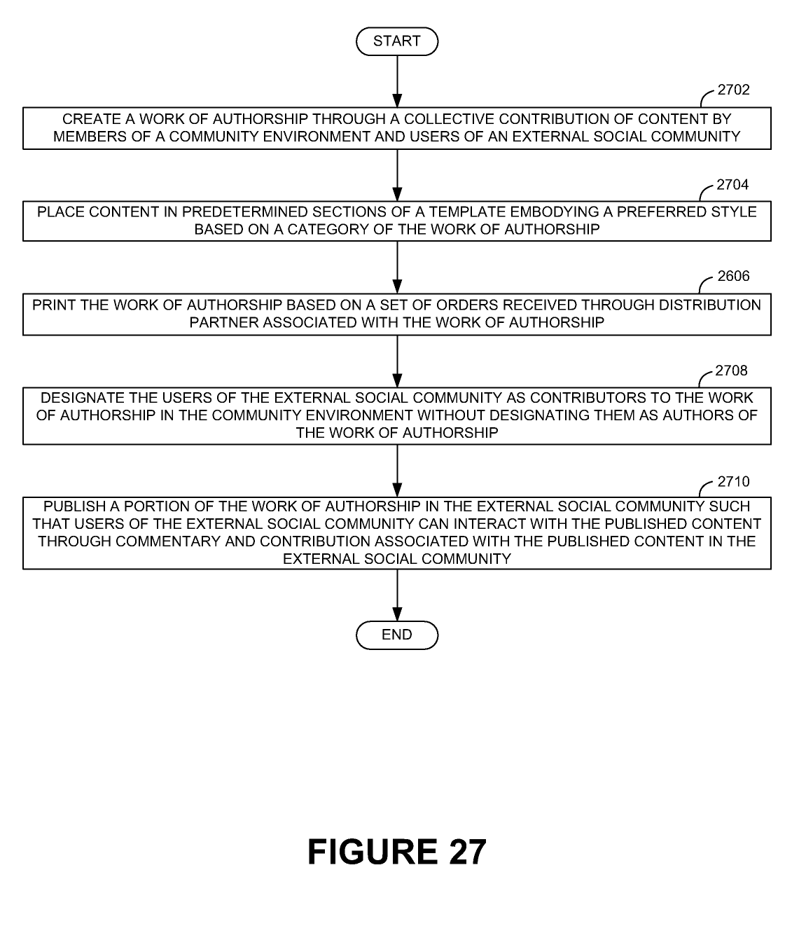

FIG. 27 is a process flow of distributing work of authorship (e.g., the work of authorship 2000 of FIG. 20) through distribution channels, according to one embodiment. In operation 2702, a work of authorship 2000 may be created through a collective contribution of content (e.g., collaborated 2012 of FIG. 20) by members of a community environment 100 and users (e.g., the users 102 of FIG. 1) of an external social community (e.g., the external social community 116 of FIG. 1). In operation 2704, content may be placed (e.g., the content placement module 2014 of FIG. 20) in predetermined sections of a template (e.g., using the template module 2104 of FIG. 21) embodying a preferred style based on a category of the work of authorship 2000 (e.g., as illustrated in FIG. 24). In operation 2706, the work of authorship 2000 may be printed based on a set of orders received through distribution partner associated with the work of authorship 2000.

In operation 2708, the users 102 of the external social community 116 may be designated as contributors to the work of authorship 2000 in the community environment 100 without designating them as authors of the work of authorship 2000. In operation 2710, a portion of the work of authorship 2000 may be published in the external social community 116 (e.g., as illustrated in FIG. 23) such that users 102 of the external social community can 116 interact with the published content through commentary and/or contribution associated with the published content in the external social community 116.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium).

For example, the various electrical structure and methods may be embodied using transistors, logic gates, and electrical circuits (e.g., Application Specific Integrated Circuitry (ASIC) and/or in Digital Signal Processor (DSP) circuitry). For example, the community network module 106, the privilege level module 108, the online project collaboration module 110, publishing module 118, the role-based module 302, the project-based module 304, the profile-based module 306, the contribution module 308, the edit module 310, the display module 312, the lock module 314, the track module 316, the revision control module 318, the archive module 318A, the comparison module 318B, the undo edits module 318C, the discussion module 320, the forum module 322, the messaging module 324, the administration module 326, the partnership module 327, the chat module 330, the community building module 332, the tag module 332A, the topics module 332B, the project rating module 332C, the user feedback module 332D, the project feedback module 332E, the user profile module 334, the friends network module 334A, the blocked user profile module 334B, the favorite projects module 334C, the customize interface module 334D, the navigation module 334E, the search module 336, the search tags module 336A, the search full text module 336B, the search topics module 336C, the post-publishing module 338, the pricing module 338A, the marketing module 338B, the author pages module 338C, the ordering module 338D, the royalties module 338E, the sales activities module 338F, the tracking module 338G, the alerts module 338H, the website module 338I, the communication module 338J, the content placement module 2014, the rss syndicator module 2004, the widget generator module 2002, the content versioning module 2006, the response analyzer module 2008, the content integration module 2010, the content placement module 2014, the page structure module 2102, the drag and drop module 2108, the cover module 2112, the template module 2104, the public/private module 2110, the theme module 2106 and other modules of FIGS. 1-27 may be enabled using a community network circuit, a privilege level circuit, an online project collaboration circuit, a publishing circuit, a role-based circuit, a project-based circuit, a profile-based circuit, a contribution circuit, an edit circuit, a display circuit, a lock circuit, a track circuit, a revision control circuit, an archive circuit, a comparison circuit, an undo edits circuit, a discussion circuit, a forum circuit, a messaging circuit, an administration circuit, a partnership circuit, a chat circuit, a community building circuit, a tag circuit, a topics circuit, a user rating circuit, a project rating circuit, a user feedback circuit, a project feedback circuit, a user profile circuit, a friends network circuit, a blocked user profile circuit, a favorite projects circuit, a customize interface circuit, a navigation circuit, a search circuit, a search tags circuit, a search full text circuit, a search topics circuit, a post-publishing circuit, a pricing circuit, a marketing circuit, an author pages circuit, an ordering circuit, a royalties circuit, a sales activities circuit, a tracking circuit, a alerts circuit, a website circuit, a communication circuit, content placement circuit, rss syndicator circuit, widget generator circuit, content versioning circuit, response analyzer circuit, content integration circuit, content placement circuit, page structure circuit, drag and drop circuit, cover circuit, template circuit, public/private circuit, theme circuit, and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method, comprising:
building a work of authorship through a collective coordination of a plurality of authors of the work of authorship in a community environment;
providing a portion of content of the work of authorship on an external social community through a feed from the community environment to the external social community;
processing a response of a user of the external social community in contributing to the work of authorship; and
integrating the response of the user of the external social community in the work of authorship.

2. The method of claim 1 wherein the response of the user of the external social community includes additional content that is incorporated into the portion of the work of authorship.

3. The method of claim 2 wherein the response of the user of the external social community includes a discussion commentary to the portion of the content of the work of authorship.

4. The method of claim 3 wherein the feed from the community environment to the external social community is displayed on a profile page in the external social community of at least one of the authors of the work of authorship collectively coordinating to the building of the work of authorship in the community environment.

5. The method of claim 1 further comprising providing the feed as at least one of a Real Simple Syndication (RSS) feed, as an embeddable widget, and an activity announcement based on an update of the work of authorship in the community environment.

6. The method of claim 5 wherein the activity announcement is presented in the external social community as a question to users of the external social community.

7. The method of claim 1 further comprising transforming the user of the external social community into one of the plurality of authors of the work of authorship in the community environment when the user of the external social community contributes content to the work of authorship through the response.

8. The method of claim 7 further comprising: customizing a presentation of content of the work of authorship through a template having a set of guidelines that define a category associated with the work of authorship.

9. The method of claim 8 further comprising:
placing content in a region of a page based on the template as directed by a request of the plurality of authors; and
assigning creative control over the placement to an editor author of the plurality of authors.

10. The method of claim 9 wherein the template is at least one of a poetry book template, a year book template, a novel template, a non-fiction book template, a picture book template, a family book template, and a multimedia book template.

11. The method of claim 9 wherein the editor author can decide roles of other authors in relation to the work of authorship, wherein the roles include at least one of a section editor role, a writer role, a contributor role, and a publisher role.

12. The method of claim 1 further comprising:
automatically publishing an update of the portion of the work of authorship embodying the response of the user in at least one other external social community upon integrating the response of the user;
publishing the work of authorship in at least one of a print form and an online form; and
distributing the work of authorship through a series of distribution channels including at least one retail distribution partner and a wholesale distribution partner.

13. A method comprising:
creating a work of authorship through a collective contribution of content by members of a community environment and users of an external social community;
placing content in predetermined sections of a template embodying a preferred style based on a category of the work of authorship; and
printing the work of authorship based on a set of orders received through at least one distribution partner associated with the work of authorship.

14. The method of claim 13 further comprising designating the users of the external social community as contributors to the work of authorship in the community environment without designating them as authors of the work of authorship.

15. The method of claim 14 further comprising: publishing a portion of the work of authorship in the external social community such that users of the external social community can interact with the published content through commentary and contribution associated with the published content in the external social community.

16. The method of claim 13 in a form of a machine-readable medium embodying a set of instructions that, when executed by a machine, causes the machine to perform the method of claim 13.

17. A system comprising:
a community environment having a suite of services that enable an author to collaborate with other authors in the community environment in writing, producing, formatting, designing and publishing a work of authorship;
a network; and
a set of external social communities associated with the author that publish a snippet of the authorship in the external social communities such that the snippet enables contribution to the work of authorship by users of the external social community.

18. The system of claim 17 wherein the contribution includes at least one of a picture content associated with the snippet, a quote associated with the snippet, a video content associated with the snippet, and a text clip associated with the snippet.

19. The system of claim 18 further comprising: a content placement module of the community environment to place content and the contribution of the work of authorship based on a pre-defined template layout chosen by the author and the other authors as a model from which to place the content and the contribution associated with the work of authorship.

20. The system of claim 17 further comprising the snippet is made visible on a profile page of at least one of the author and a plurality of authors in the external social community.
